(19) United States
(12) Patent Application Publication
(10) Pub. No.: US 2015/0296197 A1
(43) Pub. Date: Oct. 15, 2015

(54) ENCODING/DECODING METHOD AND ENCODING/DECODING DEVICE USING DEPTH INFORMATION

(71) Applicant: INTELLECTUAL DISCOVERY CO., LTD., Gangnam-gu, Seoul (KR)

(72) Inventors: Gwang Hoon Paark, Seongnam-si (KR); Yoon Jin Lee, Yongin-si (KR); Kyung Yong Kim, Suwon-si (KR); Dong In Bae, Yongin-si (KR)

(73) Assignee: INTELLECTUAL DISCOVERY CO., LTD., Seoul (KR)

(21) Appl. No.: 14/647,657

(22) PCT Filed: Nov. 27, 2013
(86) PCT No.: PCT/KR2013/010876

§ 371 Date: May 27, 2015

(30) Foreign Application Priority Data
Nov. 27, 2012 (KR) 10-2012-0135662
Nov. 27, 2012 (KR) 10-2012-0135663
Apr. 15, 2013 (KR) 10-2013-0040816
Apr. 15, 2013 (KR) 10-2013-0040819
Apr. 15, 2013 (KR) 10-2013-0040827
Apr. 15, 2013 (KR) 10-2013-0040834
Apr. 15, 2013 (KR) 10-2013-0040837

(51) Int. Cl. H04N 13/00; H04N 19/44; H04N 19/593; H04N 19/597; H04N 19/463; H04N 19/52

(52) U.S. Cl. CPC H04N 13/0048; H04N 19/463; H04N 19/52; H04N 19/593; H04N 19/597; H04N 19/44

(57) ABSTRACT

A method for inducing depth information, according to one embodiment of the present invention, comprises the steps of: receiving image data that includes depth information; generating depth configuration information from a part of the image data; obtaining movement information connected to a spatial location or a temporal location from the image data by using the depth configuration information; and decoding an image included in the image data on the basis of the obtained movement information.

### BACKGROUND OF THE INVENTION

1. Field of the Invention

The present invention relates to a method for performing prediction using a depth information image, and specifically, to an efficient method and apparatus for encoding and decoding normal images in inter prediction and intra prediction using depth information.

2. Related Art

A 3D video provides the user with 3D real-life effects through a 3D stereoscopic display apparatus. In related studies, JCT-3V (The Joint Collaborative Team on 3D Video Coding Extension Development) of ISO/IEC's MPEG (Moving Picture Experts Group) and ITU-T's VCEG (Video Coding Experts Group) currently proceeds with 3D video standardization. The 3D video standards include standards regarding advanced data formats and their related technologies that allow for replay of autostereoscopic images as well as stereoscopic images using actual images and their depth information maps.

### SUMMARY OF INVENTION

The present invention proposes an efficient method for decoding normal images in intra prediction using depth information using depth information images.

The present invention proposes a method for inducing motion information using depth information using depth information images.

The present invention comprises receiving image data including depth information; generating depth configuration information from a portion of the image data; obtaining intra prediction information using the depth configuration information; and decoding an image included in the image data based on the obtained intra prediction information.

To achieve the above objects, the present invention comprises receiving image data including depth information; generating depth configuration information from a portion of the image data; obtaining motion information associated with a spatial position or a temporal position from the image data using the depth configuration information; and decoding an image included in the image data based on the obtained intra prediction information.

The present invention may enhance the encoding efficiency of normal images. Depth information may be used in methods for encoding/decoding actual images, thus allowing for an increased encoding/decoding efficiency for actual images and reduced complexity.

### BRIEF DESCRIPTION OF THE DRAWINGS

FIG. 1 is a view illustrating the basic structure of a 3D video system and an example of a data format;

FIG. 2 is a view illustrating an exemplary actual image and an exemplary depth information map image;

FIG. 3 is a block diagram illustrating an example of a configuration of an image encoding apparatus;

FIG. 4 is a block diagram illustrating an example of a configuration of a 3D video encoding/decoding apparatus;

FIG. 5 illustrates a Kinect input device, where (a) indicates a Kinect, and (b) indicates depth information processing through the Kinect;

FIG. 6 is a view illustrating an embodiment for a configuration of a bitstream;

FIG. 7 is a view illustrating an example of intra prediction mode directions in which intra prediction encoding is performed;

FIG. 8 is a flowchart illustrating an example of an intra prediction encoding method;

FIG. 9 is a flowchart illustrating an example of a method for configuring an MPM list in intra prediction;

FIG. 10 is a view illustrating an example of a current PU block and its corresponding object information;

FIG. 11 is a view illustrating an embodiment for a method for restricting an intra prediction mode based on depth information;

FIG. 12 is a flowchart illustrating an intra prediction encoding method according to an embodiment of the present invention;

FIG. 13 is a flowchart illustrating an embodiment for a candIntraPredModeA configuration method;

FIG. 14 is a flowchart illustrating an embodiment for a candIntraPredModeB configuration method;

FIG. 15 is a flowchart illustrating an embodiment for a method for configuring an MPM list;

FIG. 16 is a view illustrating an example of a method for obtaining motion information;

FIG. 17 is a view illustrating an example of a method for configuring an AMVP (Advanced Motion Vector Prediction) list;

FIG. 18 is a view illustrating an example of neighbor blocks used to configure an AMVP list;

FIG. 19 is a flowchart illustrating an embodiment for a method for determining an MVP candidate at a spatial position;

FIG. 20 is a flowchart illustrating an embodiment for a method for determining an MVP candidate at a temporal position;

FIG. 21 is a flowchart illustrating an embodiment for a method for determining a collocated picture and a collocated block;

FIG. 22 is a flowchart illustrating an example of a method for configuring an AMVP list;

FIG. 23 is a view illustrating the correlation between a current PU block and its neighbor blocks used in an AMVP list;

FIG. 24 is a flowchart illustrating an embodiment for a method for configuring an AMVP list;

FIG. 25 is a flowchart illustrating another embodiment for a method for configuring an AMVP list;

FIG. 26 is a view illustrating an example of neighbor blocks of a current block used in a MERGE candidate list;

FIG. 27 is a view illustrating an example of a method for configuring an MERGE list;

FIG. 28 illustrates an embodiment for, in case a current block is separated into two PUs, such as (N×2N, nL×2N, nR×2N) or (2N×N, 2N×nU, 2N×nD), a spatial position of a neighbor block used in configuring the MERGE list of the second PU

FIG. 29 illustrates an embodiment for a spatial position of a neighbor block used in configuring the MERGE list for the case where a CU for a current block is 8×8, log 2_parallel_merge_level_minus2>0, and the current PU is separated into two PUs.

FIG. 30 illustrates an example of filling in an empty MERGE list using a combination method;

FIG. 31 is a flowchart illustrating an example of a method for configuring a MERGE list;

FIG. 32 is a flowchart illustrating another example of a method for configuring a MERGE list;

FIG. 33 illustrates an example of a MERGE list combination method based on depth information; and

FIG. 34 is a flowchart illustrating an embodiment for a method for configuring a MERGE list as proposed.

### DETAILED DESCRIPTION OF EXEMPLARY EMBODIMENTS

What is described below merely exemplifies the principle of the present invention. Thus, one of ordinary skill in the art, although not explicitly described or shown in this disclosure, may implement the principle of the present invention and invent various devices encompassed in the concept or scope of the present invention. It should be appreciated that all the conditional terms enumerated herein and embodiments are clearly intended only for a better understanding of the concept of the present invention, and the present invention is not limited to the particularly described embodiments and statuses.

Further, it should be understood that all the detailed descriptions of particular embodiments, as well as the principles, aspects, and embodiments of the present invention are intended to include structural and functional equivalents thereof. Further, it should be understood that such equivalents encompass all devices invented to the same function regardless of whether they are known equivalents or equivalents to be developed in the future, i.e., regardless of structures.

Accordingly, it should be understood that the block diagrams of the disclosure represent conceptual perspectives of exemplary circuits for specifying the principle of the present invention. Similarly, it should be appreciated that all the flowcharts, status variation diagrams, or pseudo codes may be substantially represented in computer-readable media, and regardless of whether a computer or processor is explicitly shown, represent various processes performed by the computer or processor.

The functions of various devices shown in the drawings including functional blocks represented in processors or their similar concepts may be provided using dedicated hardware or other hardware associated with proper software and capable of executing the software. When provided by a processor, the functions may be provided by a single dedicated processor, a single shared processor or a plurality of individual processors, and some thereof may be shared.

The explicit use of the term “processor,” “control,” or other similar concepts of terms should not be interpreted by exclusively referencing hardware capable of executing software, but understood as implicitly including, but not limited to, digital signal processor (DSP) hardware, ROMs for storing software, RAMs, and nonvolatile memories. Other known hardware may be included as well.

In the claims of the disclosure, the elements represented as means to perform the functions described in the description section are intended to include all methods for performing functions including all types of software including combinations of circuit elements for performing the functions or firmware/micro codes, and are associated with proper circuits for executing the software to perform the functions. It should be understood that the present invention defined by the claims is associated with functions provided by various enumerated means and schemes required by the claims, and thus, any means that may provide the functions belong to the equivalents of what is grasped from the disclosure.

The foregoing objects, features, and advantages will be apparent from the detailed description taken in conjunction with the accompanying drawings, and accordingly, one of ordinary skill in the art may easily practice the technical spirit of the present invention. When determined to make the subject matter of the present invention unclear, the detailed description of known configurations or functions is omitted.

Hereinafter, preferred embodiments of the present invention are described in detail with reference to the drawings.

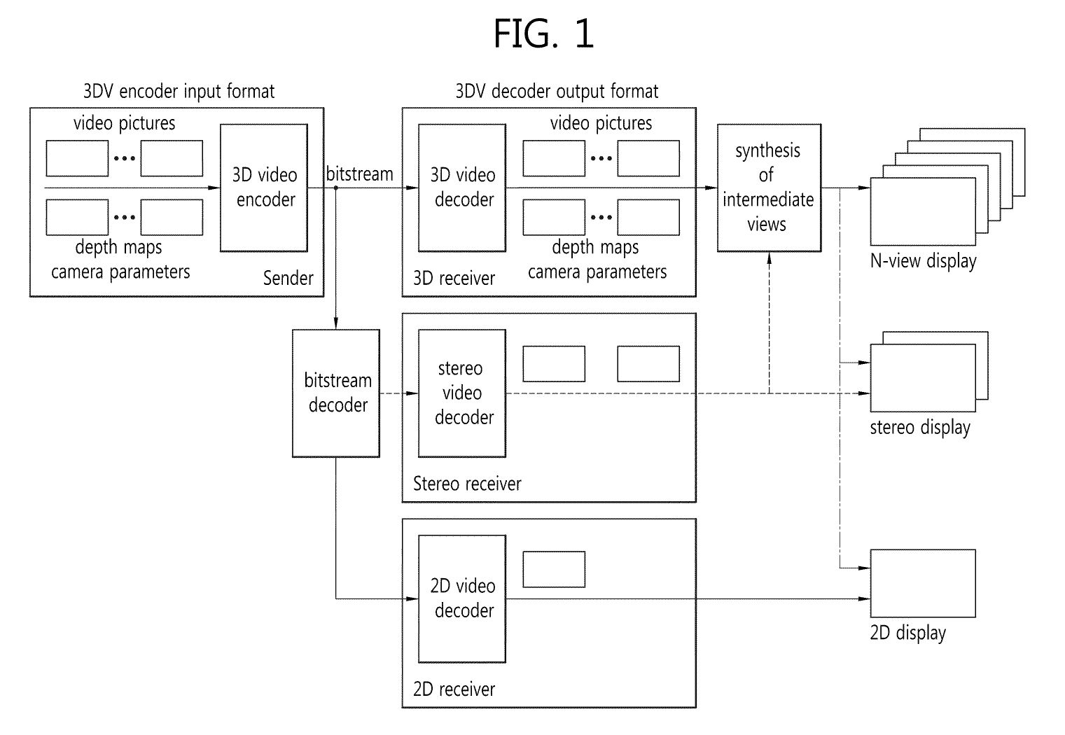

FIG. 1 illustrates the basic structure of a 3D video system and an example of a data format.

The basic 3D video system considered in the 3D video standard is shown in FIG. 1. As shown in FIG. 1, a depth information image as used in the 3D video standard is encoded together with a normal image and is transmitted to a terminal in a bitstream. An N-view (N>2) image content is obtained on the transmitting side, using a stereo camera, a depth information camera, a multi-view camera, and conversion from 2D image to 3D image. The obtained image content may contain N-view video information, its depth map information, and camera-related additional information. The N-view image content is compressed using a multi-view video encoding method, and the compressed bitstream is transmitted to the terminal through a network. The transmitted bitstream is decoded into the N-view image using a multi-view video decoding method on the receiving side. The restored N-view image generates N (or more) view virtual view images by a depth information map-based rendering (DIBR; Depth-Image-Based Rendering) process. The N or more view virtual view images generated so are played back in compliance with various stereoscopic display apparatuses to provide users with stereoscopic images.

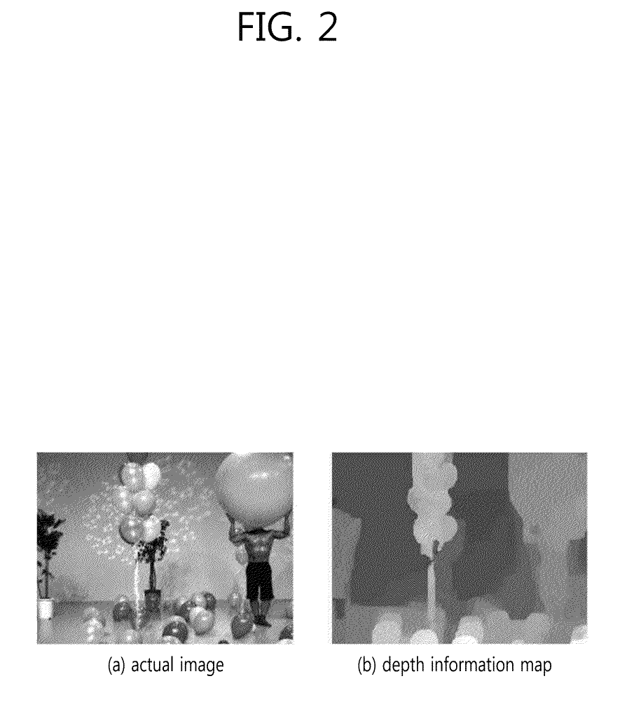

The depth information map used for generating virtual view videos is the one obtained by representing the distance between a camera and an actual object in the real-life world (depth information corresponding to each pixel at the same resolution as the actual video) in a predetermined number of bits. As an example of the depth information map is shown as a balloons image (FIG. 2(a)) and its depth information map (FIG. 2(b)) adopted in the 3D video encoding standard of the international standard organization, MPEG. The actual depth information map shown in FIG. 2 is the one obtained by representing depth information shown on the screen in eight bits per pixel.

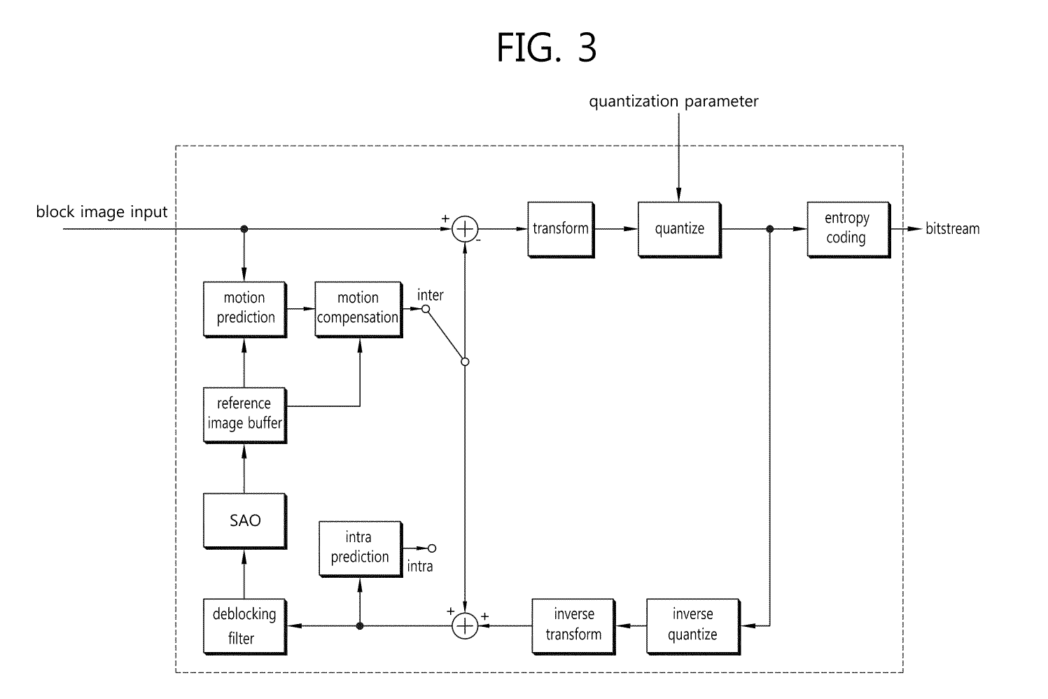

As an example of a method for encoding an actual image and its depth information map, encoding may be performed using HEVC (High Efficiency Video Coding) that is being standardized jointly by the MPEG (Moving Picture Experts Group) and the VCEG (Video Coding Experts Group). An example of the encoding structure of HEVC is shown in FIG. 3. As shown in FIG. 3, HEVC encompasses various algorithms including units and structure of encoding, inter prediction, intra prediction, interpolation, filtering, and transform methods.

FIG. 3 is a block diagram illustrating an example of a configuration of an image encoding apparatus. FIG. 3 shows the configuration of a HEVC codec-based encoding apparatus.

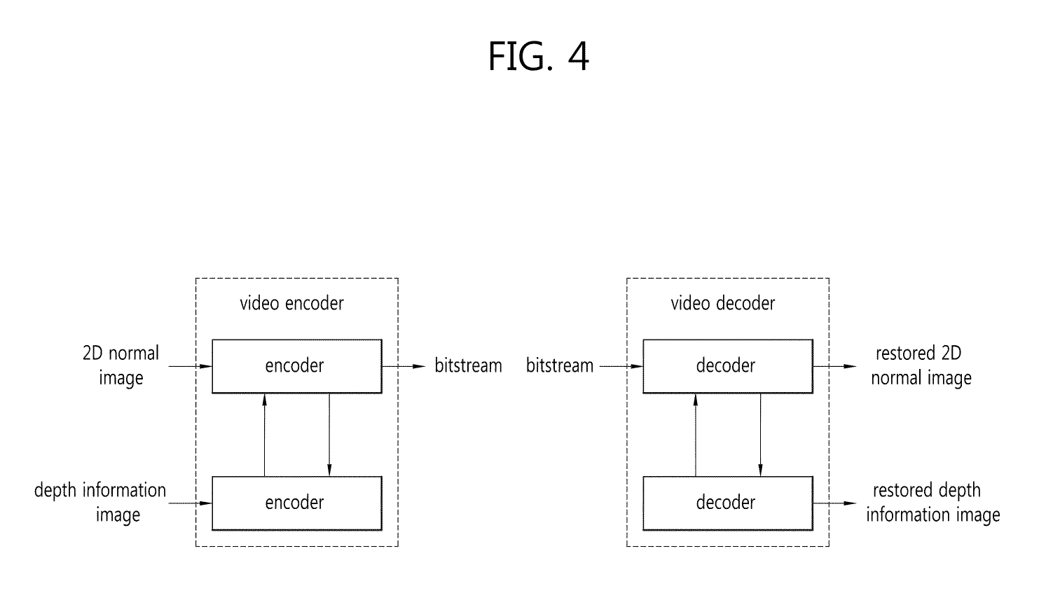

An actual video and its depth information map may be encoded and/or decoded independently from each other. Further, an actual video and a depth information map, when encoded, may be encoded and/or decoded dependently upon each other as shown in FIG. 4. In an embodiment, the actual image may be encoded/decoded using an already encoded/decoded depth information map, and on the contrary, the depth information map may be encoded/decoded using an already encoded/decoded actual image.

FIG. 4 is a block diagram illustrating an example of a configuration of a 3D video encoding/decoding apparatus.

In a 3D video codec, encoded bitstreams of an actual image and its depth information image may be multiplexed into one bitstream.

Microsoft launched the Kinect sensor as a brand-new input device for the XBOX-360 game device. This device recognizes a human operation and connects to a computer system. As shown in FIG. 3, the device includes an RGB camera and a 3D depth sensor. Further, the Kinect is an imaging device and may generate RGB images and depth information maps up to 640×480 and provide the same to a computer connected thereto.

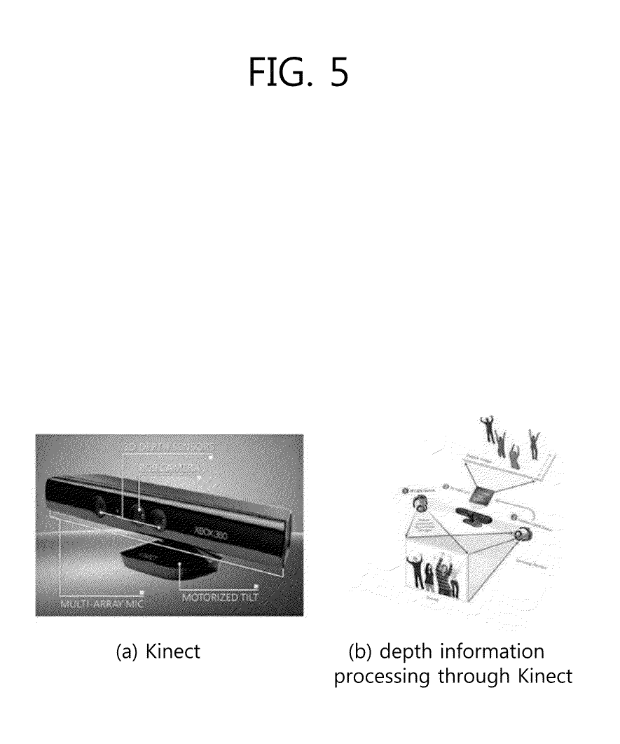

FIG. 5 illustrates a Kinect input device. (a) denotes the Kinect, and (b) denotes depth information processing through the Kinect.

The advent of imaging equipment, such as the Kinect, enabled play of 2D and 3D games and execution of imaging services or other various applications at a lower price than that of high-end video systems. Accordingly, depth information camera-equipped video apparatuses are expected to become commonplace.

As such, future video systems are expected to evolve in the form that they are combined with normal image cameras and depth cameras to basically offer 2D and 3D realistic image services as well as 2D normal image services. In other words, with such a system, the user may be simultaneously served with 3D real life-like image services and 2D high-definition image services.

A video system basically equipped with a normal camera and a depth camera may not only use depth image through a 3D video codec but also use 3D depth information through a 2D video codec.

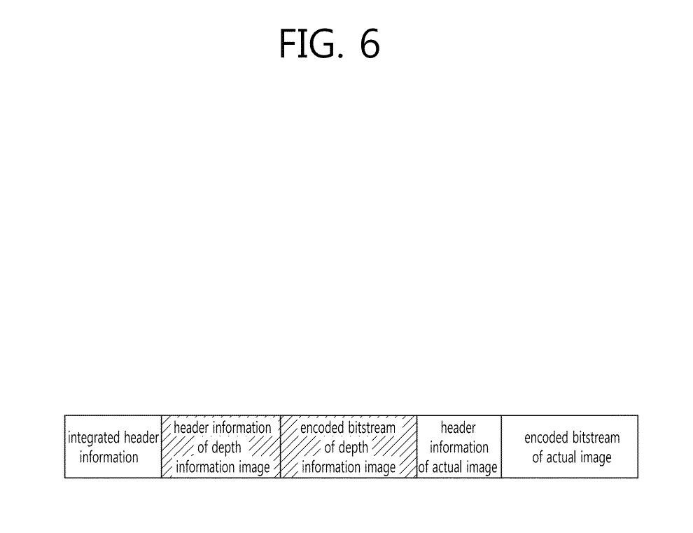

FIG. 6 illustrates an embodiment for a configuration of a bitstream;

Referring to FIG. 6, encoded bitstreams of an actual image and its depth information image may be independently configured, and may be multiplexed into one bitstream. The integrated header information of FIG. 5 may include information on parameters necessary to decode the actual image and its depth information image and generate virtual view images. The header information of the depth information image may include information on parameters necessary to decode the depth information image and generate virtual view images. The header information of the actual image may contain information on parameters necessary to decode the normal image.

Since the actual image and its depth information image have a correlation, it may be proposed for the 3D video codec to develop an algorithm considering the depth information image that may be used in the encoder/decoder.

Proposed is a method for encoding images in the 3D video codec using a depth information image by enhancing algorithms designed without reflecting use of the depth information in the 3D video codec. The basic idea of the present invention is to utilize depth information images obtained with a depth information camera to code actual images in order to maximize encoding efficiency in the 3D video codec.

In an embodiment, in case objects of a normal image are separated using a depth information image, the encoding efficiency for the normal image may be significantly increased. Here, the objects mean a number of objects and may include a background image. For a block-based encoding codec, several objects may be present in a block, and different encoding methods may apply to objects, respectively, based on depth information images.

In the HEVC encoding process, intra prediction is performed in such a manner that a block to be intended to be predicted is subjected to calculation in different ways depending on the prediction directions based on neighbor pixel values, a prediction direction in which a neighbor block is predicted is selected, and encoded.

The HEVC intra coding utilizes PU each with a size of 4×4 or up to 64×64 and offers up to 35 prediction modes. As prediction directions for use in intra coding, there are a number of predictions from a neighbor pixel of the block to be currently intended to be predicted as shown in FIG. 6, and the HEVC intra prediction adopts 33 direction modes and two special modes (DC, Planar).

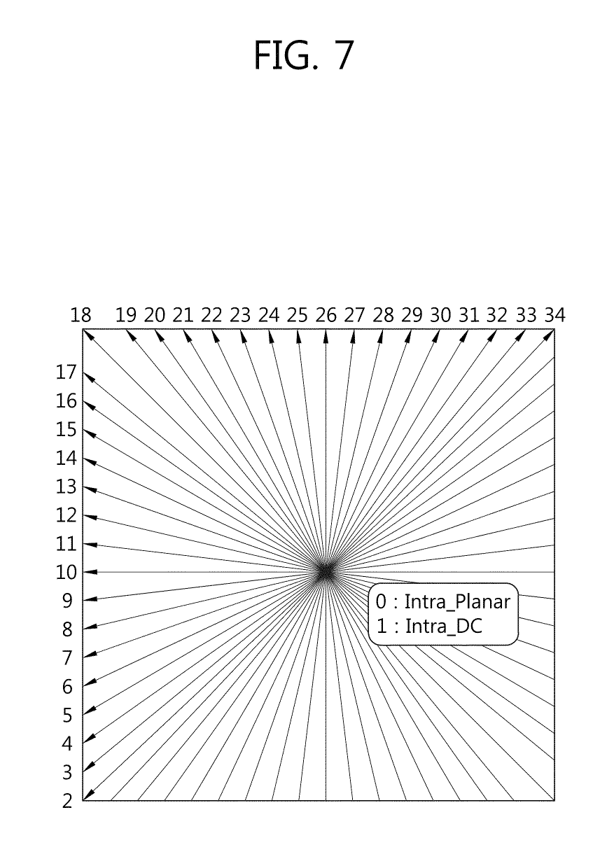

FIG. 7 illustrates an example of intra prediction mode directions in which intra prediction encoding is performed.

The intra prediction method in the HEVC intra coding algorithm supports various types of modes per prediction unit (PU) depending on the directivity regardless of the block size as shown in FIG. 7, and it supports up to 35 modes for the luma component and six modes for the chroma component.

Besides the modes according to directions as shown in FIG. 7, there are the planar mode (Planar: Intra_Planar) and average mode (DC: Intra_DC) commonly applied to the luma and chroma components and the LM mode (intra fromLuma) applied only to the chroma component.

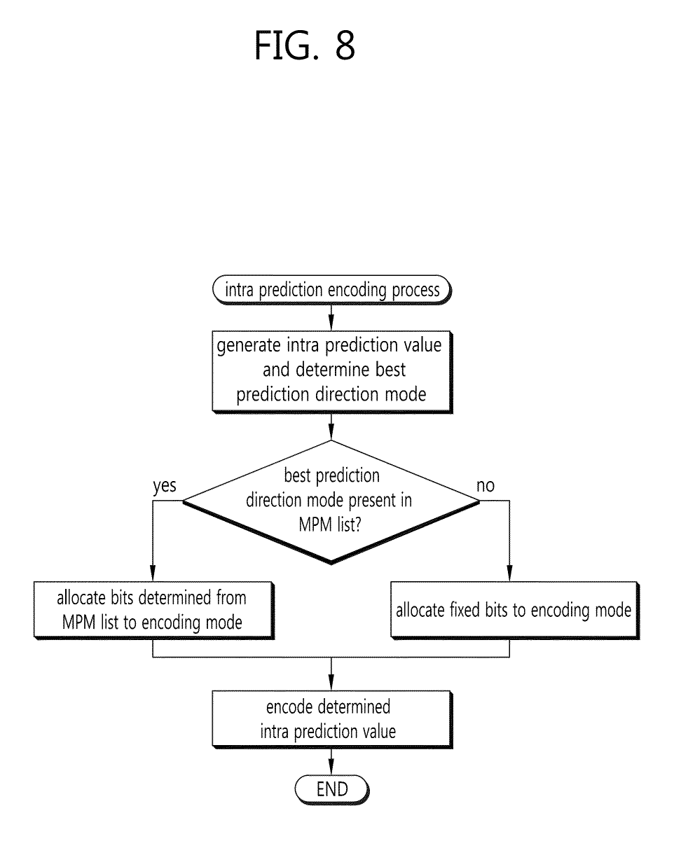

FIG. 8 is a flowchart illustrating an example of an intra prediction encoding method.

Referring to FIG. 8, the best prediction direction mode is determined through the rate-distortion function using a prior intra prediction mode for the PU to be intended to be predicted, and is compared with a configured most probable mode (MPM) list. If the MPM list contains the determined prediction direction mode, the index value and prediction block of the MPM list are encoded, and if not, fixed bits are allocated and encoded with the prediction block.

The fixed bits allocated in this process are up to five bits depending on the number of inter prediction modes.

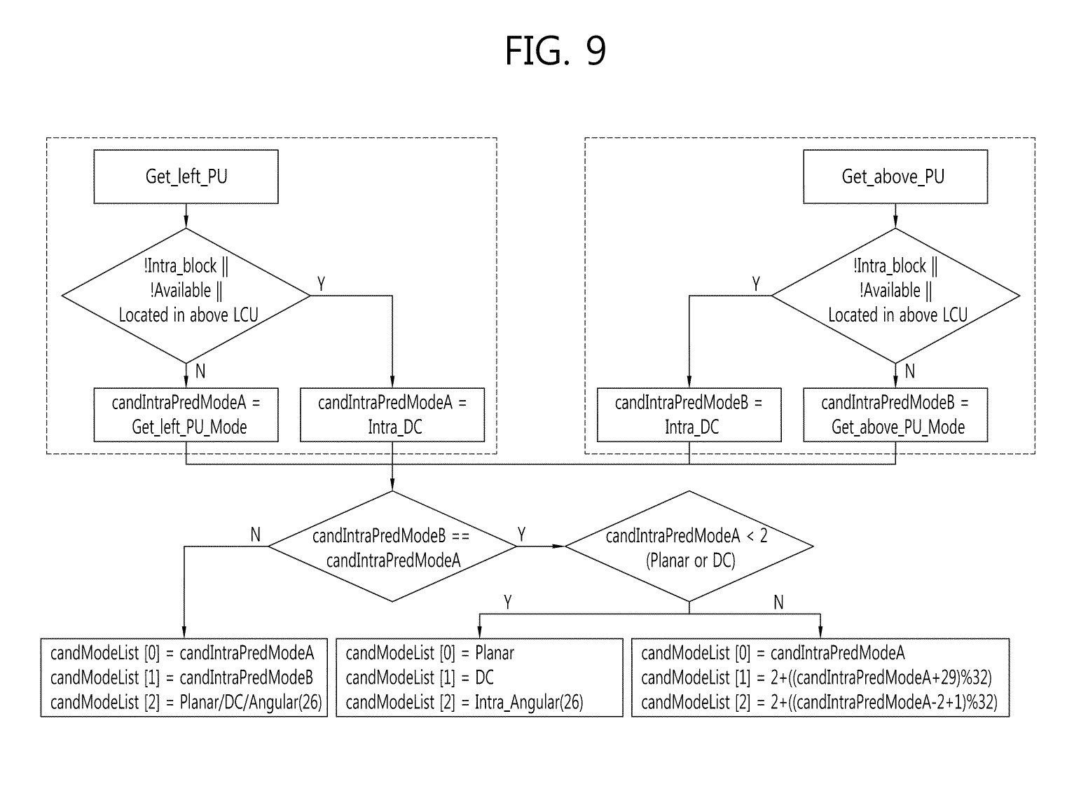

FIG. 9 is a flowchart illustrating an example of a method for configuring an MPM list in intra prediction.

Referring to FIG. 9, the MPM list is configured by reading the prediction mode information from the upper UP and left PU of the current PU to be predicted. In case a comparison made with the MPM list when performing prediction mode encoding on the current PU shows the prediction modes are the same, only the index value of the list is encoded, reducing bits as compared with when encoding is performed with fixed bits taking all the intra prediction modes as indexes. The corresponding process is shown in order as follows:

(1) Identify the information of the left PU of the current PU.

(2) In case the left PU of the current PU cannot be used or is not an intra block, if not present in the same LCU, determine candidate mode A as DC mode, otherwise determine the intra mode of the left PU as candidate mode A. Perform process (5).

(3) Identify the information of the upper PU of the current PU.

(4) In case the upper PU of the current PU cannot be used or is not an intra block, if not present in the same LCU, determine candidate mode B as DC mode, otherwise determine the intra mode of the upper PU as candidate mode B. Perform process (5).

(5) In case candidate mode A and candidate mode B are the same, perform process (7), otherwise perform process (6).

(6) In the MPM list, determine index 0 in candidate mode A and index 1 in candidate mode B. Determine index 2 in order of Planar, DC, and Angular (vertical direction) mode, finish configuring MPM list, and terminate the same.

(7) In case candidate mode A is Planar mode or DC mode, perform process (8), otherwise perform process (9).

(8) In the MPM list, determine, in order, index 0 in Planar mode, index 1 in DC mode, and index 2 in Angular (26, vertical direction) mode, finish configuring MPM list, and terminate the same.

(9) In the MPM list, determine index 0 in candidate mode A, index 1 in candidate mode A−1 (except Planar, DC mode), and index 2 in candidate mode A+1 (except Planar, DC mode), finish configuring MPM list, and terminate the same.

Restriction on Intra Prediction Direction Mode Using Depth Information

In the determination of a prediction direction in the HEVC intra prediction through the above process, prediction is performed on the direction before prediction using pixels adjacent to the current PU to determine a prediction direction mode in which the closest prediction value to the current PU is created.

However, such process does not consider object information on the neighbor block. This is so natural in light that the intra motion prediction method for the current HEVC is not equipped with any object-based encoding method.

However, once object information may be taken into account using a depth camera, the direction of intra prediction for encoding actual images may be determined as follows.

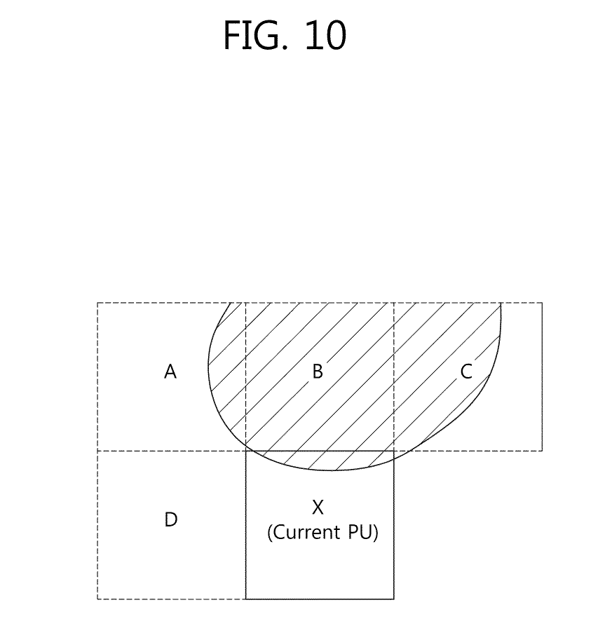

FIG. 10 illustrates an example of a current PU block and its corresponding object information.

In FIG. 10, upon intra prediction of the current PU block X, prediction is performed on all prediction directions. From the object information shown in FIG. 10, it can be guessed that intra prediction is conducted in the prediction mode with block direction D rather than in the prediction ode with block direction B, and this is attributed to the intra prediction process being performed using the neighbor pixels of the current PU. Accordingly, an intra prediction method using object information may be proposed.

Proposed is a method for performing prediction, with a reduced number of prediction modes by restricting prediction directions based on the object information rather than performing intra prediction on all prediction directions before performing intra prediction.

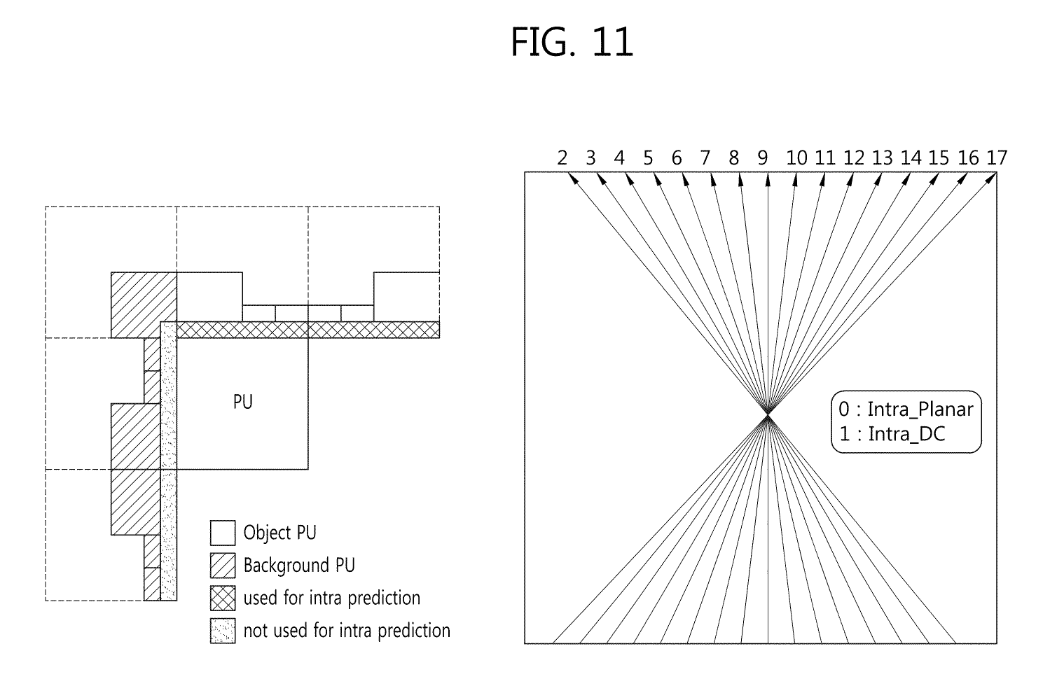

FIG. 11 illustrates an embodiment for a method for restricting an intra prediction mode based on depth information.

Referring to FIG. 11, the left PUs of the PU on which intra prediction is to be performed are PUs with different object information from that of the current PU, and the upper PUs thereof are PUs with the same object information.

In this case, the proposed method is applied to use, for intra prediction, only the prediction mode from the Planar mode, DC mode, and the prediction mode from the upper direction except the prediction mode from the left direction with different object information, without performing intra prediction on all prediction directions.

In contrast to the existing method requiring the modes for 33 directions except the Planar and DC modes, the proposed method requires only the prediction mode from one direction. Accordingly, the number of prediction modes is reduced to 19 by such method, including prediction direction modes 2 to 18 or prediction direction modes 18 to 34, the Planar mode, and the DC mode. Here, mode 10, in case the Planar mode, DC mode, and prediction direction modes 2 to 18 only are used by configuring the MPM list, and mode 26, in case only prediction direction modes 18 to 34 are used, is set to Angular, thus enabling three modes to be excluded. Accordingly, only 16 modes are used to perform fixed bit encoding, requiring four bits. This enables a one-bit saving as compared with the existing method.

Proposed is a method for determining a prediction mode, in which in the prediction encoding process of intra prediction, rather than intra prediction being performed on all prediction directions, the prediction directions are limited considering object information to reduce the number of prediction modes, thus reducing encoding bits for prediction modes. The proposed method may reduce encoding complexity by restricting prediction directions according to object information and reduce prediction mode encoding bits, thus raising encoding efficiency.

In the proposed method, upon intra prediction, the blocks that are not the same object as the current prediction block are determined based on the object information, and prediction directions from the corresponding blind decoding are restricted, reducing the number of prediction direction modes, encoding complexity, and encoding bits for prediction modes. Accordingly, the encoding efficiency may be increased.

According to the present invention, a method for reducing prediction mode encoding bits has been proposed. For that purpose, the proposed method applies only to the case where when prediction directions are restricted based on the object information, all the prediction directions from the left direction or upper direction of the current PU are limited. This is why only when one surface of the prediction direction is limited, a reduction in encoding bits due to a reduction in the number of intra prediction modes may be possible.

In the proposed method, accordingly, the 33 prediction directions (from mode 2 to mode 34) as shown in FIG. 7 are bundled up in a left direction group (from mode 2 to mode 17) and an upper direction group (from mode 18 to mode 34), and in case the whole left direction group or upper direction group is not limited, the existing method applies, and otherwise, all the prediction modes in the corresponding group are limited and intra prediction is conducted using the other modes. The prediction mode numbers used are sorted in ascending order to redefine the mode numbers.

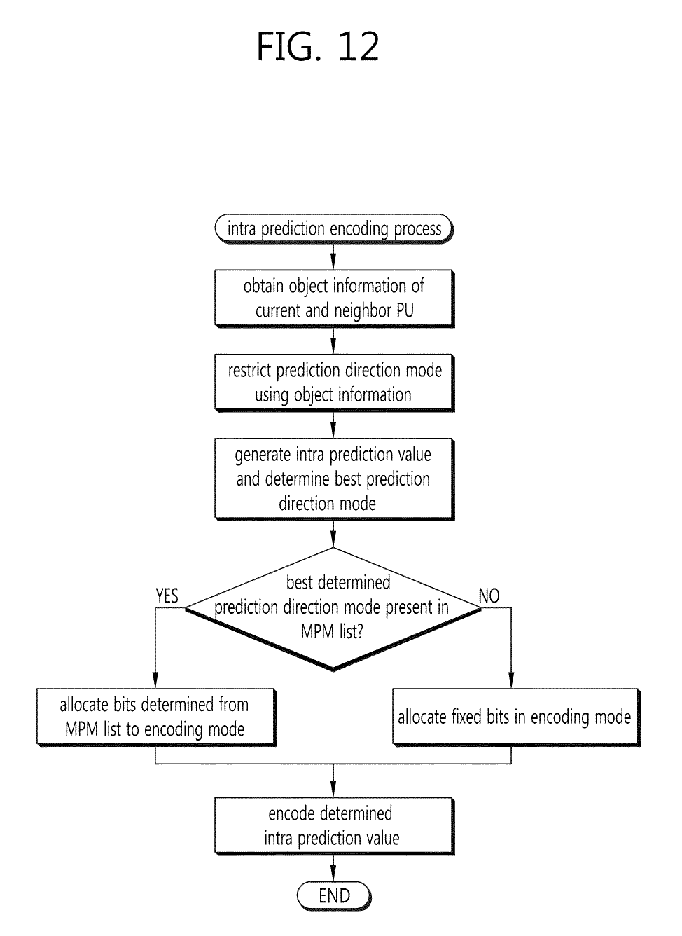

FIG. 12 is a flowchart illustrating another embodiment for an intra prediction encoding method as proposed.

The MPM list configuration method according to another embodiment of the present invention differs from the existing MPM list configuration method in a few things. While the existing method has used a vertical direction mode, mode 26, as Angular, in the MPM list configuration method, the proposed MPM list configuration method sets Angular to 26 in case only the prediction direction modes of the upper direction group are used and Angular to 10 in case only the prediction direction modes of the left direction group are used. In case the mode numbers stored in the MPM list are excluded mode numbers based on the object information through the MPM list configuration method, replacement is made in the order of Planar/DC/Angular.

Referring to FIG. 12, the intra prediction encoding method according to another embodiment of the present invention differs from the existing intra prediction encoding method in a few things.

The proposed method, unlike the existing method, starting with reading of the object information according to the current prediction block and neighbor block, performs intra prediction encoding by restricting prediction direction modes through object determination according to the object information of the current prediction block and neighbor block.

MPM List Configuration Using Depth Information

The proposed method according to another embodiment of the present invention is a prediction method in which, referring to FIG. 10, in case only the object information of upper blocks of the prediction block or only the object information of left blocks are the same as the object information of the current prediction block in configuring an MPM list of intra prediction, rather than fixed to direction mode 26 set to the Angular mode as in the existing method, if only the upper blocks of the prediction block are the same in object information as the current prediction block, the direction mode 26 is determined as the Angular mode, and if only the left blocks of the prediction block are the same in object information as the current block, direction mode 10 is determined as the Angular mode, thus increasing encoding efficiency.

According to another embodiment of the present invention, an MPM list may be configured based on object information.

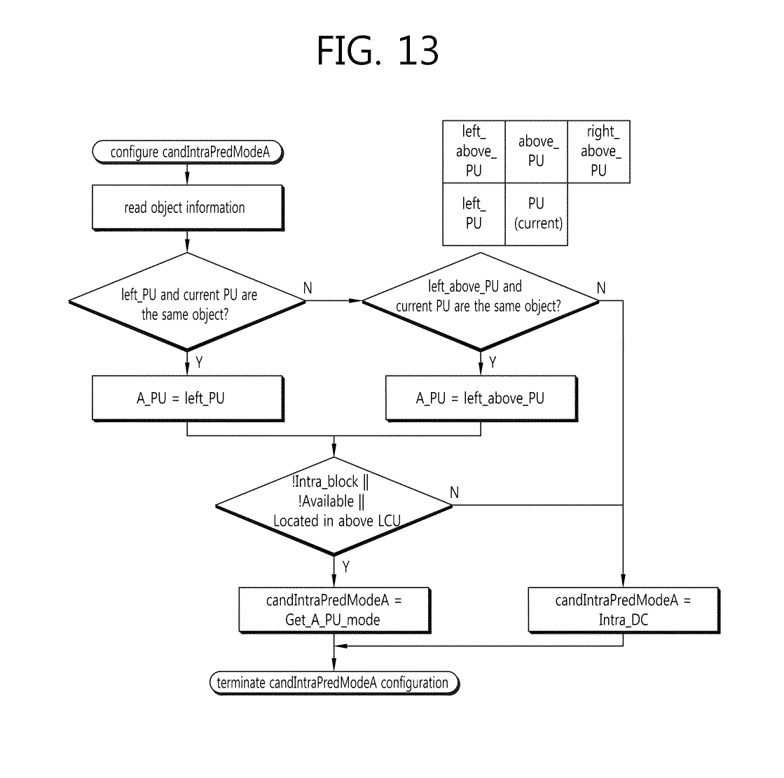

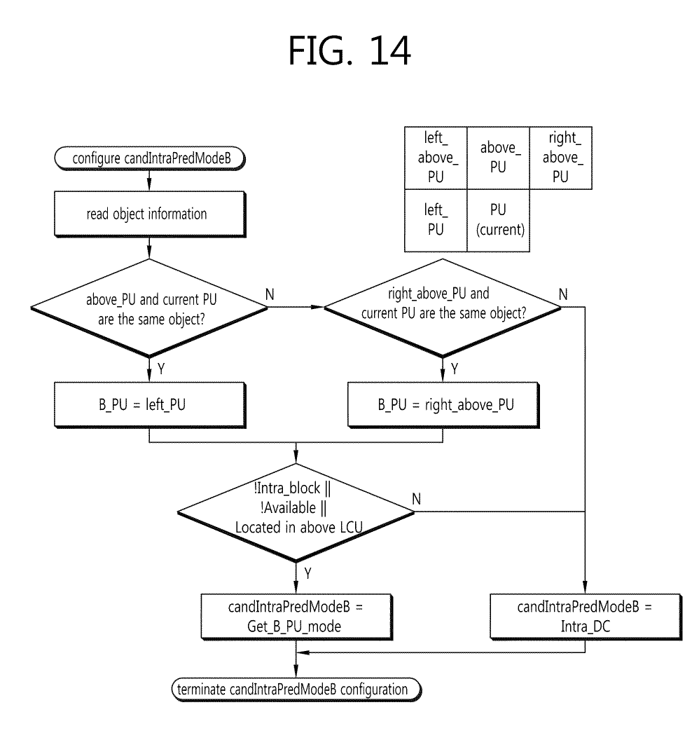

In the proposed MPM list configuration method, a method for configuring candidate modes A and B is described and shown in FIGS. 13 and 14.

FIG. 13 is a flowchart illustrating an embodiment for a candIntraPredModeA configuration method, and FIG. 14 is a flowchart illustrating an embodiment for a candIntraPredModeB configuration method.

(1) Identify object information on the current PU and a neighbor PU for configuring candidate mode A as shown in FIG. 13.

(2) Identify whether the left PU (left_PU) is the same in object as the current CU, and if the same object, read the information on the left PU and perform process (4).

(3) Unless the left PU is different in object from the current PU, identify whether the left and upper PU (left_above_PU) is the same in object as the current PU, and if the same object, read the information on the left and upper PU and perform process (4). Otherwise, perform process (5).

(4) In case the corresponding PU whose information has been read through processes (2) and (3) or is not an intra block, unless present in the same LCU, perform process (5), and otherwise, determine candidate mode A as the intra prediction mode of the corresponding PU.

(5) Determine candidate mode A as DC mode and terminate the candidate mode A configuration process.

In the proposed MPM list configuration method, a method for configuring candidate mode B is similar to the method for configuring list candidate mode A. What differs from the process for configuring candidate mode A is that in process (3) the left and upper PU is replaced with the right and upper PU (right_above_PU) as shown in FIG. 13.

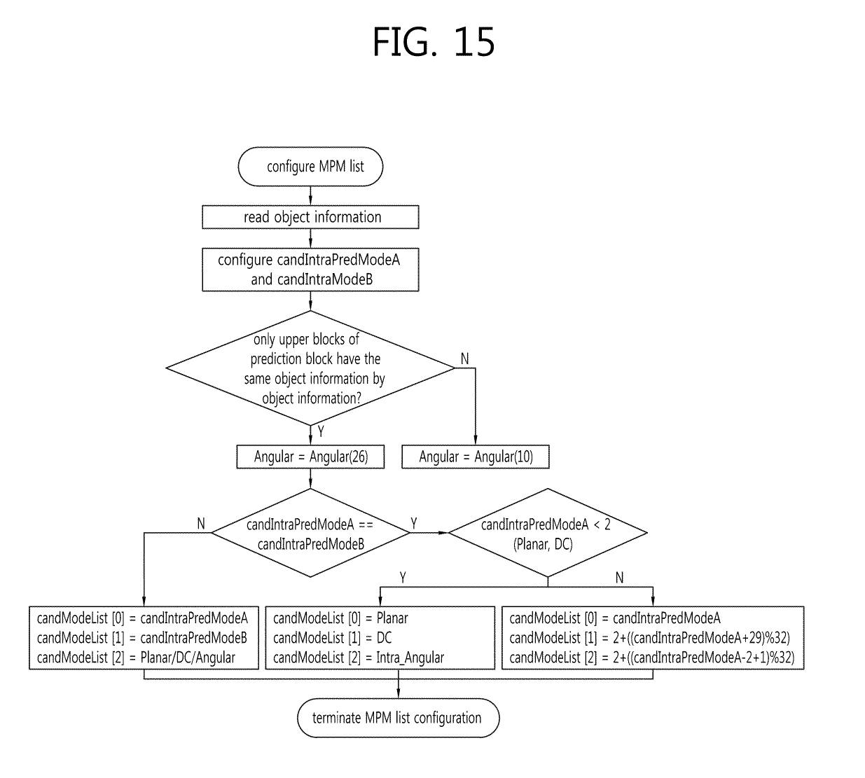

FIG. 15 is a flowchart illustrating an embodiment for a method for configuring an MPM list.

(1) Identify object information on the current PU and a neighbor PU.

(2) Configure candidate modes A and B for configuring an MPM list.

(3) In case only the left blocks of the current prediction block are the same by the object information, determine horizontal direction mode 10 as Angular mode, and in case only upper blocks of the current prediction block are the same, determine vertical direction mode 26 as Angular mode.

(4) In case candidate mode A and candidate mode B are the same, perform process (6), otherwise perform process (5).

(5) In the MPM list, determine index 0 with candidate mode A and index 1 with candidate mode B. Determine index 2 in order of Planar, DC, and Angular mode, finish configuring MPM list, and terminate the same.

(6) In case candidate mode A is Planar mode or DC mode, perform process (7), otherwise perform process (8).

(7) In the MPM list, determine, in order, index 0 in Planar mode, index 1 in DC mode, and index 2 Angular, finish configuring MPM list, and terminate the same.

(8) In the MPM list, determine index 0 in candidate mode A, index 1 in candidate mode A−1 (except Planar, DC mode), and index 2 in candidate mode A+1 (except Planar, DC mode).

An MPM list configuration method has been described above as proposed herein.

Referring to FIG. 15, the proposed object information-based HEVC intra prediction method, adding an object information-based process, differs from the existing method in a few things.

In the proposed method, the object information on the current PU and a neighbor PU is grasped first. Unless the prediction direction based on the object information for the current PU is not the whole upper direction or whole left direction, the existing method applies, and otherwise, the proposed processes as shown in FIG. 15 are undergone.

The above-described methods may vary in applicable ranges depending on the block sizes or CU depths. As the variable (i.e., size or depth information) for determining an applicable range, a value predetermined in the encoder/decoder or a value determined according to a profile or level may be used, or if the encoder specifies a variable value in the bitstream, the decoder may obtain the variable value from the bitstream. In case different applicable ranges apply depending on CU depths, as exemplified in the following table, there may be a scheme (method A) in which it applies only to a given depth or more, a scheme (method B) in which it applies only to the given depth or less, or a scheme (method C) in which it applies to the given depth only.

Table 1 represents an example of a range determination scheme that applies the methods according to the present invention in case the given CU depth is 2. (0: applies to a corresponding depth, X: does not apply to a corresponding depth)

TABLE 1

| CU depth indicating applicable range | Method A | Method B | Method C |
|---|---|---|---|
| 0 | X | ◯ | X |
| 1 | X | ◯ | X |
| 2 | ◯ | ◯ | ◯ |
| 3 | ◯ | X | X |
| 4 | ◯ | X | X |

In case the methods according to the present invention do not apply all depths, it may be denoted with some indicator (flag) or may be represented by signaling with a CU depth value indicating an applicable range that is one larger than the maximum value of the CU depth.

Further, the above-described method may apply to color difference blocks in different ways according to the size of the brightness block, and may apply to brightness signal images and color difference images in different manners as well.

TABLE 2

| Brightness block size | Color difference block size | Apply brightness | Apply color difference | Methods |
|---|---|---|---|---|
| 4(4 × 4, 4 × 2, 2 × 4) | 2(2 × 2) | ◯ or X | ◯ or X | A1, 2, . . . |
| | 4(4 × 4, 4 × 2, 2 × 4) | ◯ or X | ◯ or X | B1, 2, . . . |
| | 8(8 × 8, 8 × 4, 4 × 8, 2 × 8 etc) | ◯ or X | ◯ or X | C1, 2, . . . |
| | 16(16 × 16, 16 × 8, 4 × 16, 2 × 16 etc) | ◯ or X | ◯ or X | D1, 2, . . . |
| | 32(32 × 32) | ◯ or X | ◯ or X | E1, 2, . . . |
| 8(8 × 8, 8 × 4, 2 × 8 etc) | 2(2 × 2) | ◯ or X | ◯ or X | F1, 2, . . . |
| | 4(4 × 4, 4 × 2, 2 × 4) | ◯ or X | ◯ or X | G1, 2, . . . |
| | 8(8 × 8, 8 × 4, 4 × 8, 2 × 8 etc) | ◯ or X | ◯ or X | H1, 2, . . . |
| | 16(16 × 16, 16 × 8, 4 × 16, 2 × 16 etc) | ◯ or X | ◯ or X | I1, 2, . . . |
| | 32(32 × 32) | ◯ or X | ◯ or X | J1, 2, . . . |
| 16(16 × 16, 8 × 16, | 2(2 × 2) | ◯ or X | ◯ or X | K1, 2, . . . |
| 4 × 16 etc) | 4(4 × 4, 4 × 2, 2 × 4) | ◯ or X | ◯ or X | L1, 2, . . . |
| | 8(8 × 8, 8 × 4, 4 × 8, 2 × 8 etc) | ◯ or X | ◯ or X | M1, 2, . . . |
| | 16(16 × 16, 16 × 8, 4 × 16, 2 × 16 etc) | ◯ or X | ◯ or X | N1, 2, . . . |
| | 32(32 × 32) | ◯ or X | ◯ or X | O1, 2, . . . |

Table 2 represents an example of a combination of the methods.

Among the varied methods shown in Table 2, method Sa 1 is described. In case the size of the brightness block is 8 (8×8, 8×4, or 2×8) and the size of the color difference block is 4 (4×4, 4×2, or 2×4), the method as described herein may apply to brightness signals and color difference signals.

Among the varied methods above, method Pa 2 is described. In case the size of the brightness block is 16 (16×16, 8×16, or 4×16) and the size of the color difference block is 4 (4×4, 4×2, or 2×4), the method as described herein may apply to brightness signals, but not to color difference signals.

In other varied methods, the method as disclosed herein may apply to only brightness signals, but not to color difference signals. Conversely, the method as disclosed herein may apply to only color difference signals, but not to brightness signals.

The above-described methods according to the present invention may be prepared in a computer executable program that may be stored in a computer readable recording medium, examples of which include a ROM, a RAM, a CD-ROM, a magnetic tape, a floppy disc, or an optical data storage device, or may be implemented in the form of a carrier wave (for example, transmission through the Internet).

The computer readable recording medium may be distributed in computer systems connected over a network, and computer readable codes may be stored and executed in a distributive way. The functional programs, codes, or code segments for implementing the above-described methods may be easily inferred by programmers in the art to which the present invention pertains.

Meanwhile, one of methods for encoding motion information in inter prediction of the HEVC encoding process is a MERGE method (hereinafter, simply “MERGE”). MERGE may come in units of encoding units (hereinafter, “CUs”) and in units of prediction units (hereinafter, “PUs”). In case MERGE is performed in units of CUs or PUs (hereinafter, referred to as blocks for ease of description), there are a need for information regarding whether MERGE is performed for each block partition or information regarding which one of the neighbor blocks of the current block (e.g., a left neighbor block of the current block, an upper neighbor block of the current block, or a temporal neighbor block of the current block) MERGE is performed with.

The MERGE candidate list refers to a list storing motion information and is created before MERGE is performed. The motion information stored in the MERGE candidate list may be motion information of a neighbor block adjacent to the current block or motion information of a (collocated) block corresponding to the current block in the reference image. Further, the motion information stored in the MERGE candidate list may be brand-new motion information created by combining the motion information already present in the MERGE candidate list.

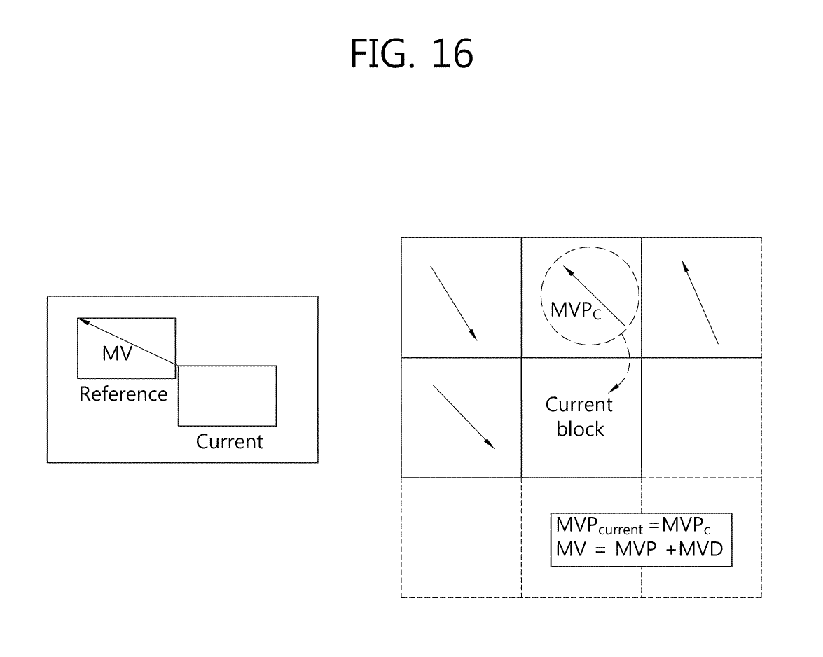

FIG. 16 is a view illustrating an example of a method for obtaining motion information. The MV is obtained from a distance between a block to be currently predicted and a closest block in the reference image as shown in FIG. 16. An MVD is obtained through an MVP determined through the neighbor block of the current block and the obtained MV value and is used in an encoding process.

In the process of obtaining the motion information, the MVP is determined taking the neighbor block of the block to be predicted as a candidate. This only differs in methodology from any other video codecs but not in that the neighbor block of the block to be predicted is taken as an MVP candidate block.

However, such process does not consider object information on the neighbor block.

This is so natural in light that the MVP determination method in the intra motion prediction for the current HEVC is not equipped with any object-based encoding method.

However, once object information may be taken into account using a depth camera, the MVP determination for encoding actual images may be determined as follows:

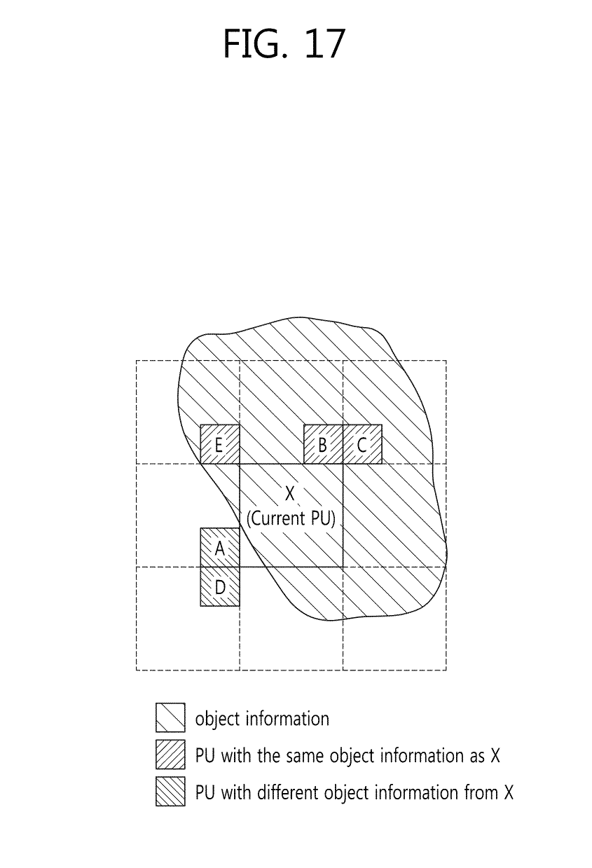

FIG. 17 is a view illustrating an example of a method for configuring an AMVP (Advanced Motion Vector Prediction) list.

In FIG. 17, among the MVP candidate blocks for block X, blocks C and D are of the same object, and blocks A and B are blocks out of the object. In such case, since blocks C and D may be said to have motion in similar directions as the same object block, such information may be said to have to be first used in MVP determination.

One of methods for encoding motion information in the HEVC inter coding algorithm is an inter coding mode (AMVP: Advanced Motion Vector Prediction) method. AMVP is a method in which several MVP candidate list are created using neighbor blocks, and the best MVP candidate is determined, and the reference image and the candidate index values of the MVD and MVP are encoded in motion information through motion prediction.

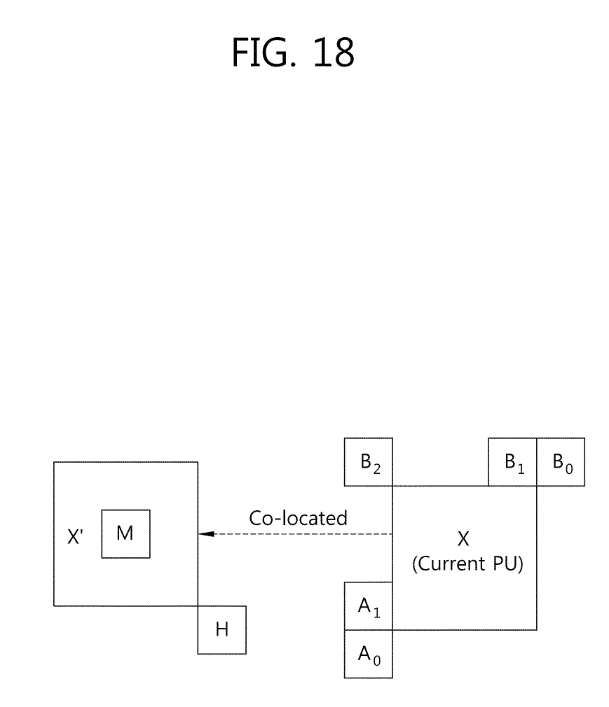

FIG. 18 is a view illustrating an example of neighbor blocks used to configure an AMVP list.

The AMVP list refers to a list storing motion information. The motion information stored in the AMVP list may be motion information of a neighbor block adjacent to the current block or motion information of a (collocated) block corresponding to the current block in the reference image, as shown in FIG. 18.

The AMVP list is configured by make splitting on the candidate block (H or M) at the same position in the reference image and the neighbor blocks (A0, A1, B0, B1, B2) of a prediction unit (PU) X block of FIG. 18 into two MVPs at the spatial position (one MVP from the left block (A0, A1) and one MVP from the upper block (B0, B1, B2)) and one MVP at the temporal position, and in case the number of MVPs at the spatial position does not reach two, adding one MVP at the temporal position to total two.

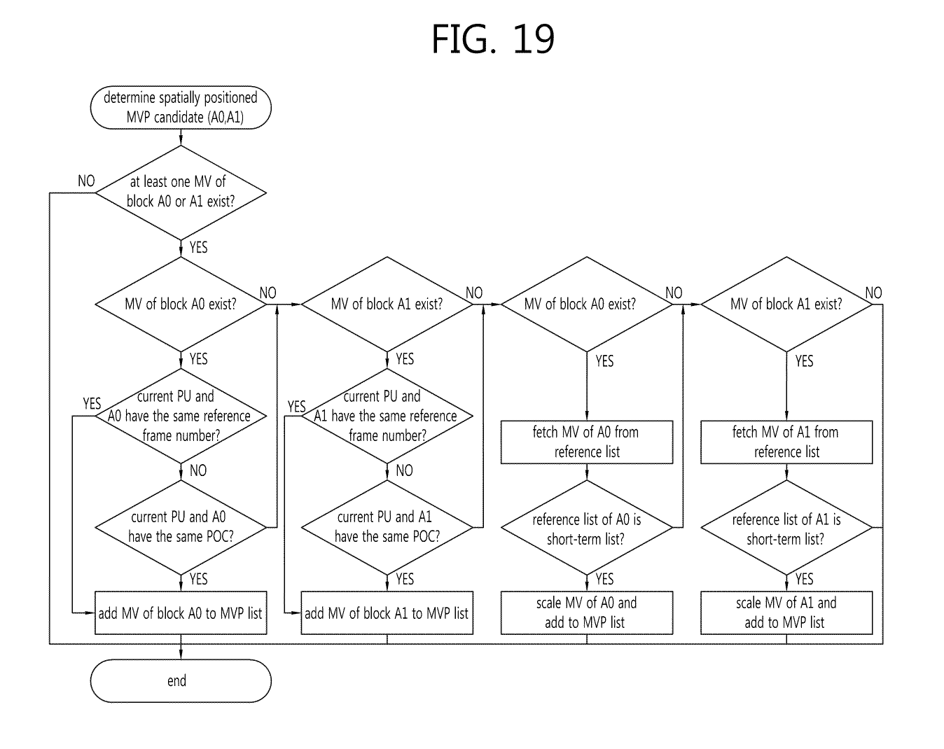

FIG. 19 is a flowchart illustrating an embodiment for a method for determining an MVP candidate at a spatial position.

The method for determining an MVP candidate at the spatial position is the same as that shown in FIG. 19, and the MVP candidate is stored for the block (A0, A1) at the spatial position in the following order.

(1) Terminate unless neither block A0 nor A1 has MV.

(2) Perform process (5) unless block A0 has MV.

(3) Identify whether block A0 and the current PU have the same reference frame number (reference index), and if having the same reference frame number, store the MV of A0 and terminate.

(4) Identify whether block A0 and the current PU have the same POC (Picture Order Count), and if having the same POC, store the MV of A0 and terminate.

(5) Identify whether block A1 and the current PU have the same reference frame number, and if having the same reference frame number, store the MV of A1 and terminate.

(6) Identify whether block A1 and the current PU have the same POC (Picture Order Count), and if having the same POC, store the MV of A1 and terminate.

(7) In case block A0 has MV, if the MV of the corresponding frame is a short-term reference picture (Short-term picture) through the reference frame number of block A0, scale and store the MV and terminate.

(8) In case block A1 has MV, if the MV of the corresponding frame is a short-term reference picture (Short-term picture) through the reference frame number of block A1, scale and store the MV and terminate.

The MVP candidates are determined for blocks B0, B1, and B2 in the same manner.

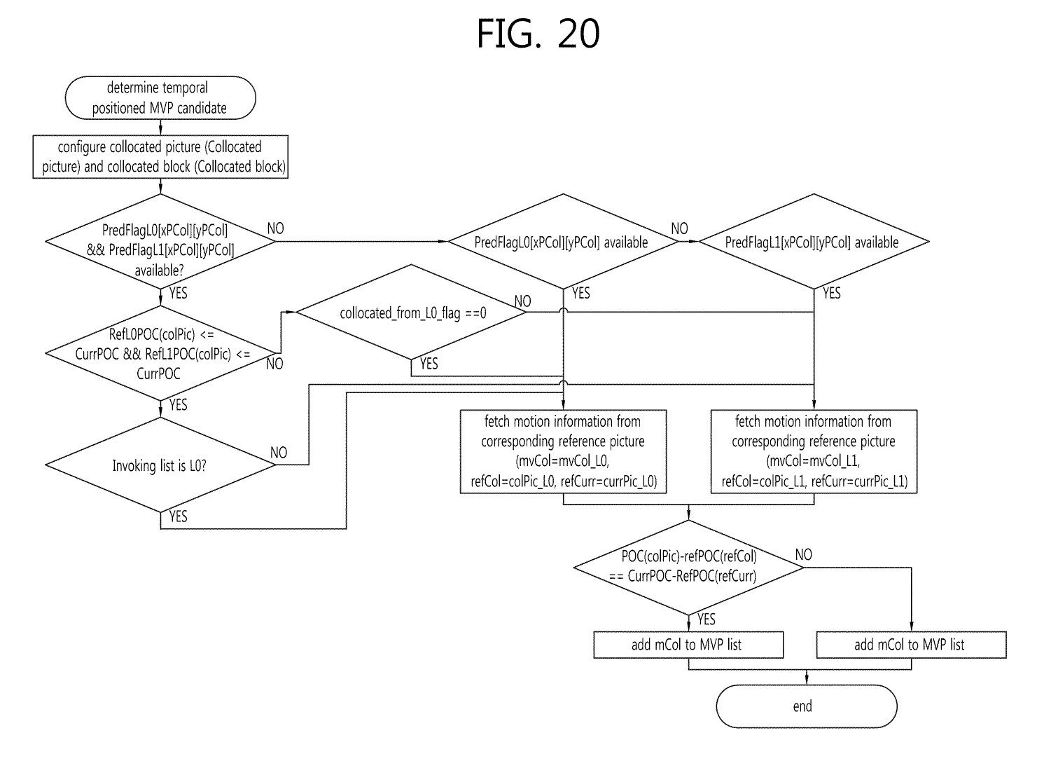

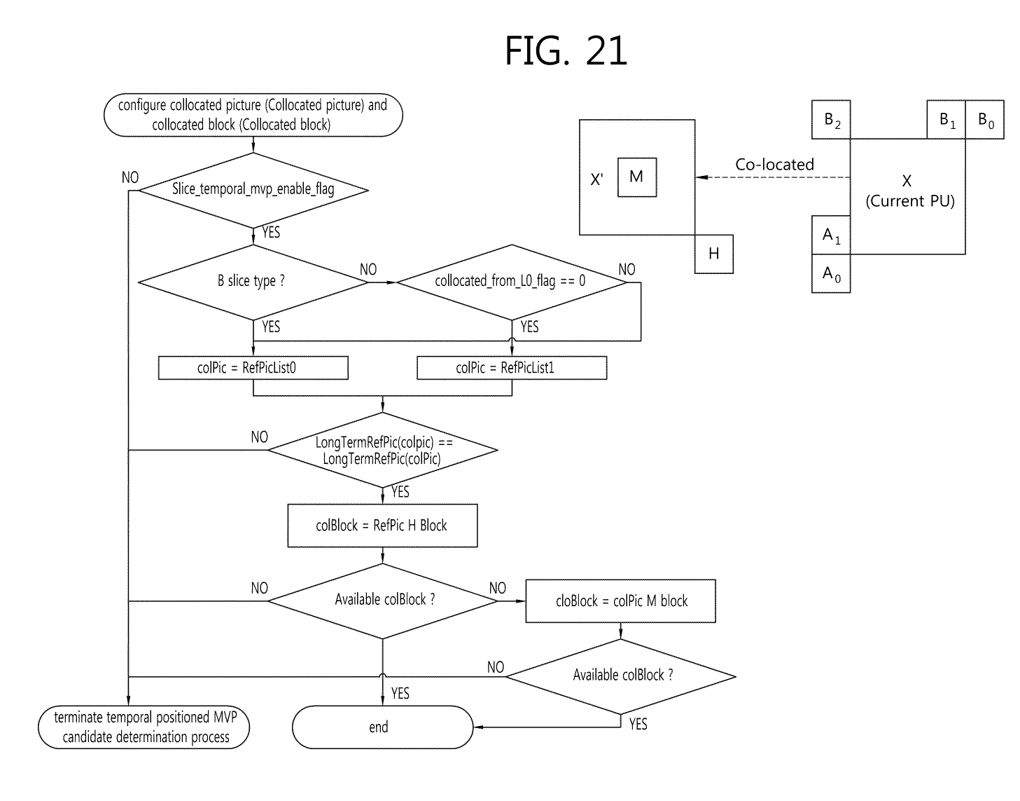

FIG. 20 is a flowchart illustrating an embodiment for a method for determining an MVP candidate at a temporal position, and FIG. 21 is a flowchart illustrating an embodiment for a method for determining a collocated picture and a collocated block.

The terms in FIG. 20 are as follows.

currPic: Current picture

colPic: Collocated picture

xPCol, yPCol: x, y of collocated picture

PredFalgL0: Prediction flag of reference picture list L0

PredFlagL1: Prediction flag of reference picture list L1

POC: Picture Order Count

RefL0POC(colPic): L0 POC of colPic

RefL1POC(colPic): L1 POC of colPic

CurrPOC: POC of current picture

mvCol_L0: MV brought from reference picture list L0 of colPic

mvCol_L1: MV brought from reference picture list L1 of colPic

colPic_L0: reference picture brought from reference picture list L0 of colPic

colPic_L1: reference picture brought from reference picture list L1 of colPic

currPic_L0: reference picture brought from reference picture list L0 of current picture

currPic_L1: reference picture brought from reference picture list L1 of current picture

The terms in FIG. 21 are as follows.

currPic: Current picture

colPic: Collocated picture

RefPicList0: reference picture brought from reference picture list L0 of current picture

RefPicList1: reference picture brought from reference picture list L1 of current picture

LongTermRefPic: Long-term reference picture

colBlock: Collocated block

The method for determining an MVP candidate at the temporal position is the same as that shown in FIG. 20, and the MVP candidate is stored for the block (H or M) at the temporal position in the following order. The process of determining an MVP candidate at the temporal position consists of configuring a collocated block after configuring a collocated picture and storing an MV from the collocated block.

The configuration of the collocated picture and the collocated block is shown in FIG. 21. The corresponding process is performed in the following order.

(1) Unless the current PU can use the TVMP (Temporal MVP) (when slice_temporal_mvp_enable_plag is 0), terminate the MVP candidate determination at the temporal position.

(2) Identify whether the slice of the current PU is slice B. If not slice B, set the reference picture of reference picture list L0 to collocated picture and perform process (4).

(3) In case collocated_from_{—}10_flag is 0, set the reference picture of reference picture list L1 to the collocated picture. In case the value is 1, set the reference picture of reference picture list L0 to the collocated picture.

(4) Unless the long-term picture of the current picture and the long-term picture of the collocated picture configured through processes (2) and (3) is the same, terminate the determination of the MVP candidate at the temporal position.

(5) Set the block at the right and lower end (block H in FIG. 8) with respect to the same position as the current PU in the collocated picture to the collocated block. In this case, if block H departs from the LCU, perform process (7).

(6) In case the collocated block (block H) is an intra block, perform process (7), and in case an inter block, finish the process of configuring the collocated picture and block.

(7) Since it is impossible to set block H to the collocated block, set the center of the reference position (block M in FIG. 8) to the collocated block.

(8) In case the collocated block (block M) is an intra block, terminate the MVP candidate determination at the temporal position and in case an inter block, finish the process of configuring the collocated picture and block.

The configuration of the collocated picture and block is finished, and such a process is performed in which the MV at the temporal position is obtained and stored. The process is performed in the following order.

(1) Examine whether the collocated block is a block predicted from the reference picture of reference picture list L0 and L1 of the collocated picture.

(2) In case the collocated block is a block predicted only with the reference picture of reference picture list L0 of the collocated picture, fetch the motion information (motion vector, reference picture number) from reference picture list L0 of the collocated picture and perform process (8).

(3) In case the collocated block is a block predicted only with the reference picture of reference picture list L1 of the collocated picture, fetch the motion information (motion vector, reference picture number) from reference picture list L1 of the collocated picture and perform process (8).

(4) Determine whether the POCs of the reference pictures of reference picture lists L0 and L1 of the collocated picture are all smaller than the POC of the picture of the current PU. If all the POCs smaller, perform process (5) and otherwise process (7).

(5) In case the reference picture of the current PU is the reference picture of its reference picture list L0, fetch the motion information (motion vector, reference picture number) from reference picture list L0 of the collocated picture and perform process (8).

(6) In case the reference picture of the current PU is the reference picture of its reference picture list L1, fetch the motion information (motion vector, reference picture number) from reference picture list L1 of the collocated picture and perform process (8).

(7) Fetch the motion information (MV, reference picture number) from reference picture list L0 of the collocated picture if collocated_from_{—}10_flag is determined to be 0, and from reference picture list L1 if determined to be 1, and perform process (8).

(8) If the POC difference between the current picture and the reference picture of the current PU is compared with the POC difference from the picture referenced by the collocated block and shows the same, store the MV from the fetched motion information and terminate. If different, scale and store the MV from the fetched motion information and terminate.

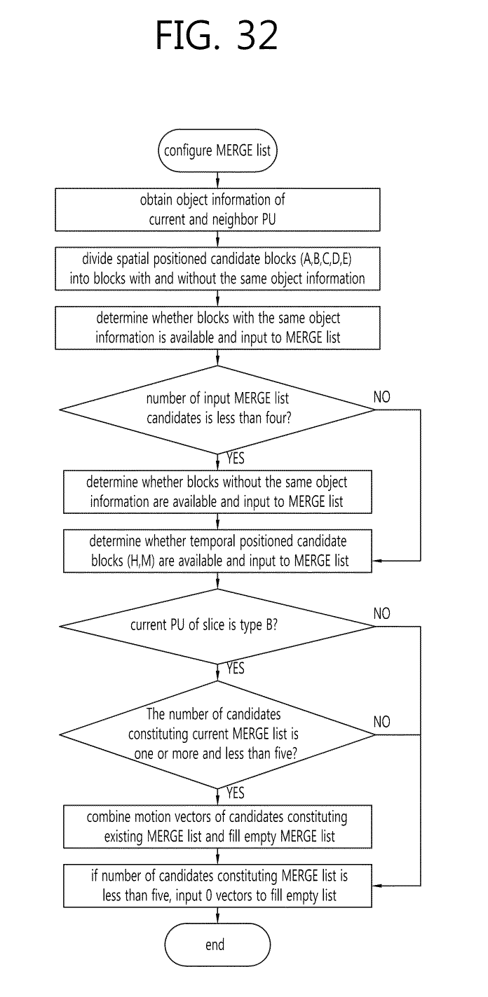

FIG. 32 is a flowchart illustrating another example of a method for configuring a MERGE list.

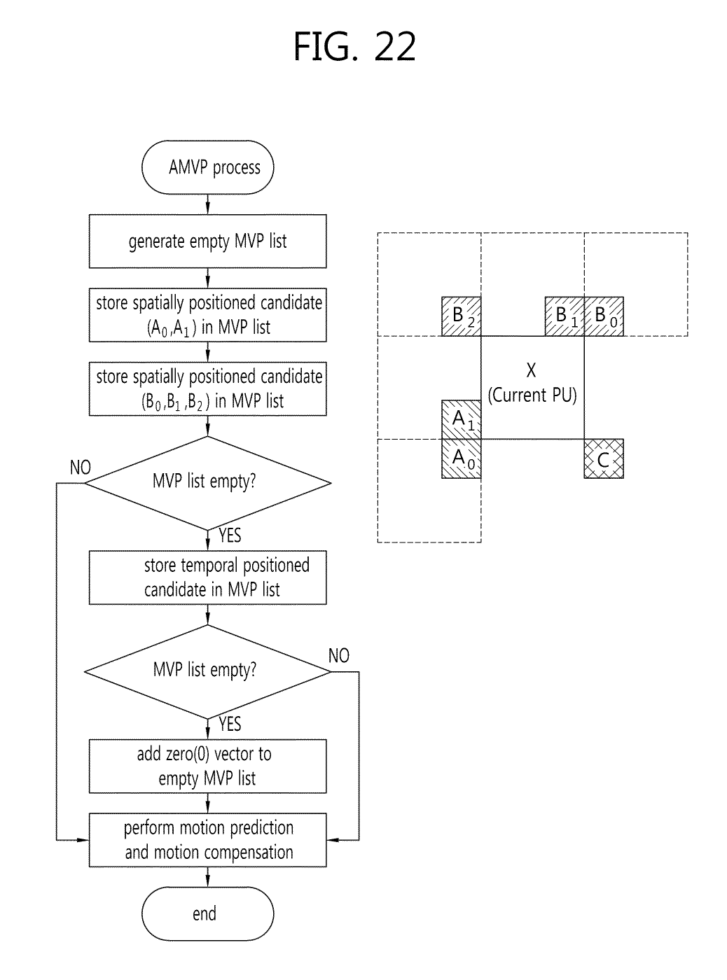

Referring to FIG. 22, the AMVP list is configured through the MVP at the spatial position and the MVP at the temporal position and the process is performed in the following order.

(1) Check if the motion information of A0 uses the same reference image as the current PU (block X). In case the same reference image is used, store in the MVP candidate list and go to process (3). Unless the same reference image is used, check whether the motion information of A1 uses the same reference image as the current PU (block X), and if the same reference image is used, store in the MVP candidate list and go to process (3), while unless the same reference image is used proceeding with process (2).

(2) In case the reference image of A0 is different from the reference image of the current PU (block X), obtain the scale value of A0 and the current PU (block X), store the scaled motion information in the MVP candidate list, and go to process (3). Unless A0 has motion information, compare the reference image of A1 with the reference image of the current PU (block X). In case the reference image of A1 is different from the reference image of the current PU, obtain the scale value of A1 and the current PU (block X), store the scaled motion information in the MVP candidate list, and go to process (3). Unless A1 has motion information, determine that there is no left block MVP candidate mode and go to process (3).

(3) For upper blocks (B0, B1, B2), discover MVP candidates in the order of B0, B1, and B2 in the same process as (1) and (2).

Last, if there is a remaining space in the MVP candidate list, add the temporal MVP candidate to the MVP candidate list. The temporal MVP candidate is configured using the motion information of the (collocated) block corresponding to the current PU (block X). In the process of configuring an AMVP list as shown in FIG. 22, an AMVP list is first configured from the MVP candidate at the spatial position. In this case, if no MVP candidate at the spatial position is available so it is impossible to store two MVP candidates, if the MVP at the temporal position is available, add it to the AMVP list. However, if going through all the MVP candidate determination process of the spatial position or temporal position, the AMVP list is not filled up (upon failure to come up with two), a 0 vector is stored in the AMVP list.

AMVP List Configuration Using Depth Information

A method for determining an MVP by determining MVP candidate blocks considering object information in MVP determination may be proposed, in which the MVP candidate blocks are limited depending on the object information to thus reduce encoding complexity while allowing for more precise MVP determination, resultantly leading to an enhanced encoding efficiency.

The HEVC AMVP candidate list configuration method does not use object information in determining an MVP candidate block either. Accordingly, this may be proposed as a method for configuring an AMVP candidate list through the object information using the depth information. In the proposed method, motion information is restricted on all the neighbor MVP candidate blocks based on the object information in configuring an AMVP candidate list through the object information based on the depth information, thus reducing the complexity in the AMVP candidate list configuration method. Further, the encoding efficiency may be increased by a method of first storing the motion information on the blocks of the same object.

A first proposed method is a method using depth information in a method of storing two spatial MVP candidates in configuring an AMVP candidate list. An example may be a method of differentiating objects using the depth information and first storing the MVP of the block of the same object as the current PU block corresponding to the current PU block generating the AMVP candidate list and its neighbor block.

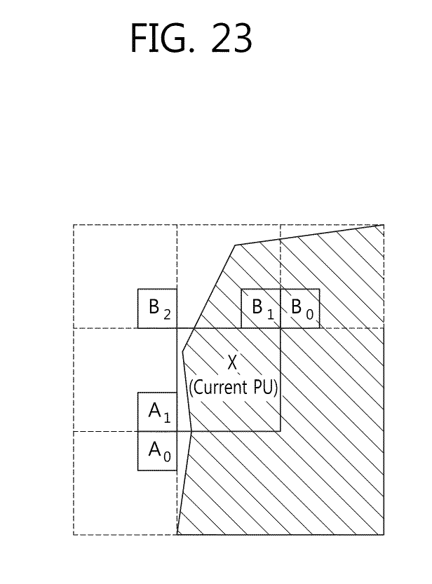

FIG. 23 illustrates the correlation between a current PU block and its neighbor blocks used in an AMVP list.

Referring to FIG. 23, it may be separated on a per-object basis based on the depth information, and this may be shown corresponding to the current PU (block X) used as the AMVP list and neighbor blocks.

The method according to an embodiment of the present invention stores the motion information in block B0 or B1 and temporal MVP candidates excluding A0, A1, and B2, which are not of the same object as the current PU (block X), from the AMVP list configuration, configuring the AMVP list. In this case, if neither block B0 nor B1 has motion information, motion information is discovered in the order of blocks A0, A1, and B2, and the spatial MVP candidates are stored.

(1) If neighbor blocks A0, A1, B0, B1, and B2 are all present in the same object as the current PU (block X), the existing AMVP list configuration method is used to store the two spatial MVP candidates.

(2) If among neighbor blocks A0, A1, B0, B1, and B2, any is not present in the same object as the current PU (block X), the neighbor blocks not in the same object are excluded, and the existing AMVP list configuration method is used to store the spatial MVP candidates. In case there is no spatial MVP candidate stored in the process of storing the spatial MVP candidate except the candidate blocks with different object information in the candidate blocks at the spatial position, the temporal MVP candidate is stored, and regardless of the object information, motion information is discovered in the order of A0, A1, B0, B1, and B2, configuring the AMVP list.

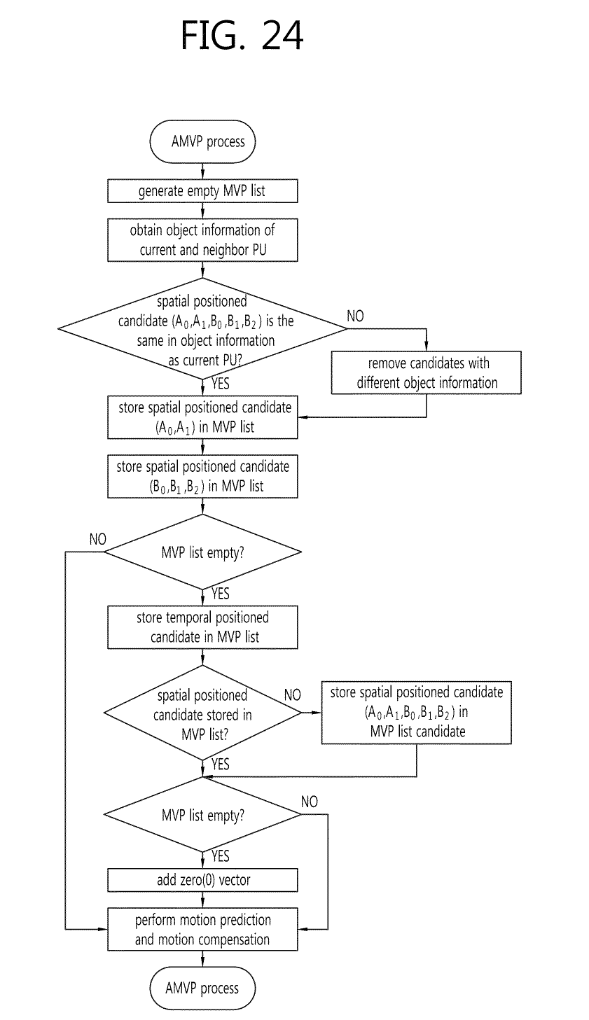

FIG. 24 is a flowchart illustrating an embodiment for a method for configuring an AMVP list.

Referring to FIG. 24, the method according to an embodiment of the present invention proceeds with a few distinctions as compared with the above-described AMVP list configuration method.

The existing method starts to configure an AMVP list determining the MVP candidate at the spatial position. In the proposed method, however, starting with reading the object information according to the corresponding block and the neighbor block, an object determination is performed depending on the object information of the current prediction block X and the neighbor block to, unless block X is in the same object of the block where the corresponding MVP candidate is positioned at the spatial position, remove this. The MVP candidates at the spatial position are adjusted through such process, configuring an AMVP list in the order of determination of an MVP candidate at the spatial position and determination of an MVP candidate at the temporal position. In this case, if there is an empty space in the AMVP list, the 0 vector is stored as in the existing method, finishing the list configuration.

In another method as proposed, in case the current PU (block X) is present in the same object as the (collocated) block corresponding to the current PU (block X) in FIG. 17, the temporal MVP candidate is first stored, and one spatial MVP candidate is stored, configuring an AMVP list.

(1) In case the current PU (block X) is present in the same object as the (collocated) block corresponding to the current PU (block X), first store the temporal MVP candidate. If there is no temporal MVP candidate, the existing AMVP list configuration method is followed.

(2) Store one spatial MVP candidate to configure an AMVP list using the existing AMVP list configuration method.

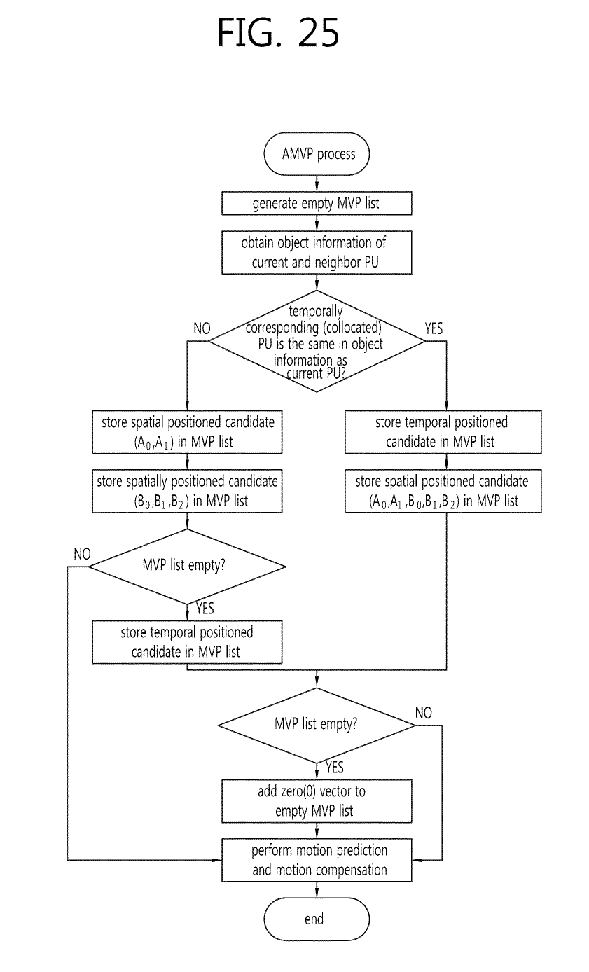

FIG. 25 is a flowchart illustrating another embodiment for a method for configuring an AMVP list.

Referring to FIG. 25, the method according to another embodiment of the present invention proceeds with a few distinctions as compared with the above-described AMVP list configuration method.

Although in the existing method configuration of an AMVP list is started from determining an MVP candidate at the spatial position, a determination is made as to whether the current prediction block X and the MVP candidate block at the temporal position are of the same object starting with reading the object information according to the corresponding block and the neighbor block, and if the same object and the MVP candidate at the temporal position is available, it is stored in the AMVP list, and an MVP candidate at the spatial position is discovered, finishing the AMVP list configuration. Unless the MVP candidate block at the temporal position is not in the same object, an AMVP list is configured from MVP candidates at the spatial position. If an AMVP list cannot be configured even through the MVP candidates at the temporal and spatial position, a 0 vector is stored, and the list configuration is finished.

MERGE List Configuration Using Depth Information

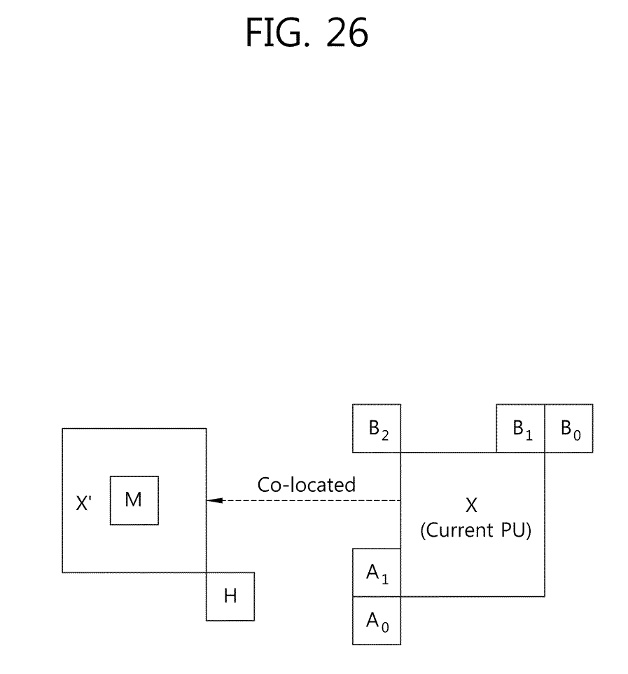

FIG. 26 is a view illustrating an example of neighbor blocks of a current block used in a MERGE candidate list.

In the process of obtaining the motion information, the MERGE list configuration is determined taking the neighbor block of the block to be predicted as a candidate. This only differs in methodology from any other video codecs but not in that the neighbor block of the block to be predicted is taken as a candidate block.

However, such process does not consider object information on the neighbor block.

This is so natural in light that the MERGE list configuration method in the intra motion prediction for the current HEVC is not equipped with any object-based encoding method.

However, once object information may be taken into account using a depth camera, the following may be done for encoding actual images.

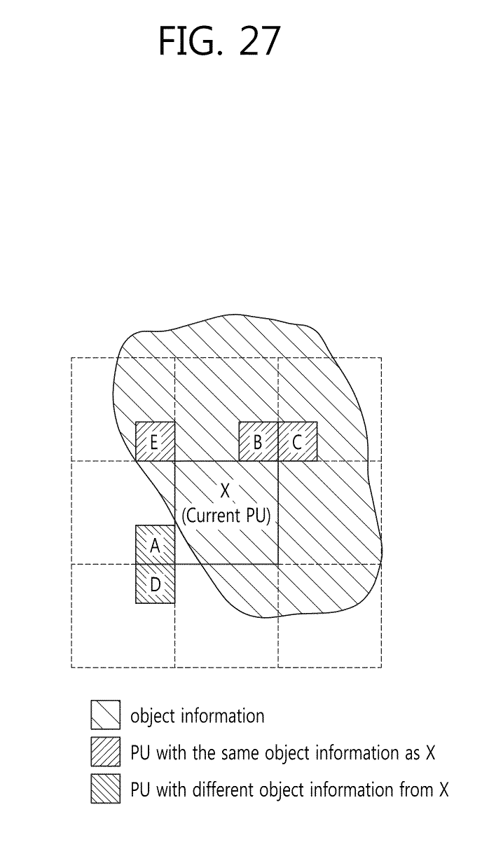

FIG. 27 is a view illustrating an example of a method for configuring an MERGE list; In FIG. 27, among the candidate blocks for block X, blocks B, C, and E are of the same object, and blocks A and D are blocks out of the object. In such case, since blocks C and D may be said to have motion in similar directions as the same object block, such information may be said to have to be first used in the MERGE list configuration.

A MERGE list with a total of five candidate blocks is configured by adding one temporal positioned candidate block to four of the five spatial position candidate blocks for the candidate block at the same position (H or M) in the reference image and the neighbor blocks (A, B, C, D, E) of the prediction unit (PU) block X. In case the number of MERGE list candidate blocks does not reach five, the motion information already present in the MERGE candidate list are combined and input to the list.

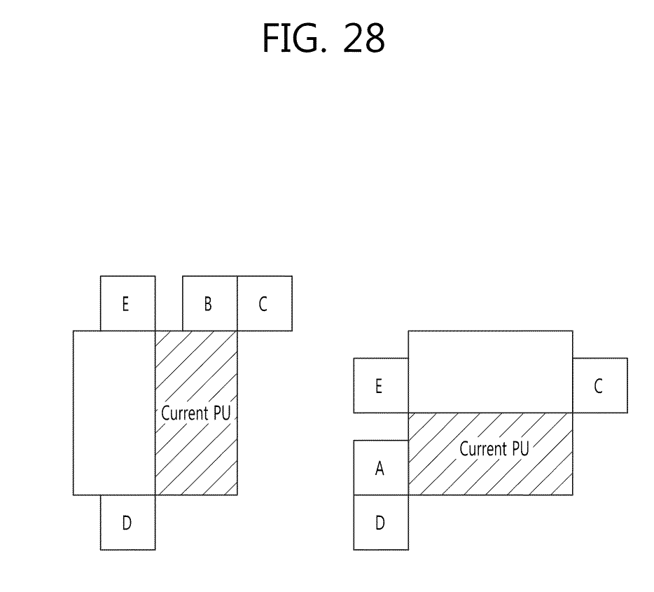

FIG. 28 illustrates an embodiment for, in case a current block is separated into two PUs, such as (N×2N, nL×2N, nR×2N) or (2N×N, 2N×nU, 2N×nD), a spatial position of a neighbor block used in configuring the MERGE list of the second PU.

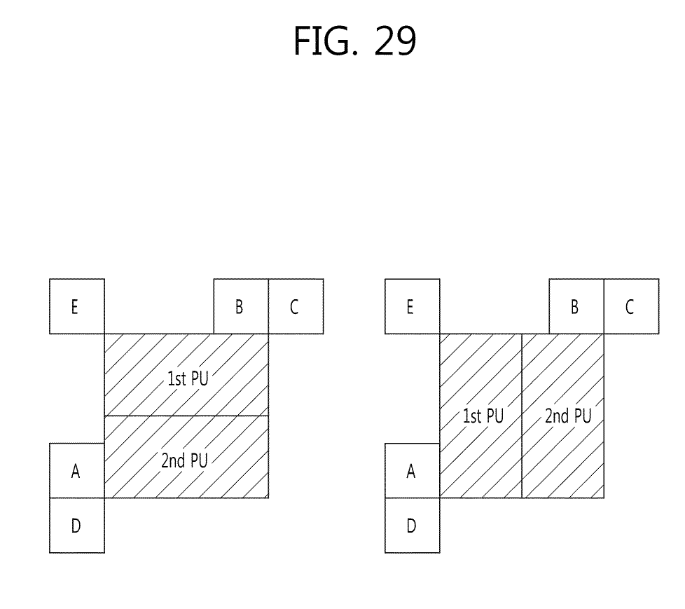

FIG. 29 illustrates an embodiment for a spatial position of a neighbor block used in configuring the MERGE list for the case where a CU for a current block is 8×8, log 2_parallel_merge_level_minus2>0, and the current PU is separated into two PUs.

In the method for determining a spatial position candidate block, as shown in FIGS. 26, 28, and 29, the positions of blocks A, B, C, D, and E get through the following conditions in the order of A>B>C>D>E to thus discover up to four candidate blocks.

(1) In case the positioned candidate block is an intra block, unavailable.

(2) In case of the lack of the positioned candidate block, unavailable.

(3) In case the current PU is split into two PUs as shown in FIG. 28, only blocks B, C, D, and E if the second PU of them corresponds to (N×2N, nL×2N, nR×2N), and only blocks A, C, D, and E if the PU corresponds to (2N×N, 2N×nU, 2N×nD) may be used for the MERGE list configuration.

(4) In case the current PU is 8×8 and log 2_parallel_merge_level_minus2>0, current blocks A, B, C, D, and E at the positions shown in FIG. 29 may be used.

In a method for determining temporal positioned candidate blocks, the collocated picture is configured for the current PU, and then the collocated block is configured. Thereafter, it is determined in the order of H>M as shown in FIG. 25. In this case, the current PU should be able to use the TMVP (Temporal MVP). (slice_temporal_mvp_enable_plag is 1) After a MERGE list is configured using the spatial position candidate blocks and the temporal positioned candidate blocks, if the slice type of the current PU is slice B, and the number of MERGE list candidates is less than five, the existing candidates are combined to adjust the number of MERGE list candidates up to five. Such process is performed in the following order.

(1) If the slice type of the current PU is not slice B, terminate.

(2) If the number of MERGE list candidates is 0 or empty, fill up with up to five candidates and then terminate the process.

(3) As per the index order shown in Table 3, fill up the MERGE list with up to five candidates and then terminate the process. In this case, if the process is done up to the end of the index order shown in Table 3, the process is terminated.

TABLE 3

| combIdx | 0 | 1 | 2 | 3 | 4 | 5 | 6 | 7 | 8 | 9 | 10 | 11 |
|---|---|---|---|---|---|---|---|---|---|---|---|---|
| 10CandIdx | 0 | 1 | 0 | 2 | 1 | 2 | 0 | 3 | 1 | 3 | 2 | 3 |
| 11CandIdx | 1 | 0 | 2 | 0 | 2 | 1 | 3 | 0 | 3 | 1 | 3 | 2 |

Table 3 represents the order in which an empty MERGE list is created by combining existing candidate lists. combIdx refers to the turns of the candidates that should fill the list, and l0CandIdx and l1CandIdx refer to the motion vectors of L0 and L1 of the candidates input in the existing MERGE list. Taking as an example the first row of Table 3, combIdx=0, denoting that the first motion vector of the candidate that should fill the list, and L0 and L1, denoting the L0 motion vector of the first index and the L1 motion vector of the second index of the existing MERGE list, are input to create candidates. In this case, if there is no motion vector of l0CandIdx or L1CandIdx, and thus, a predetermined combination is impossible to create, the l0CandIdx and L1CandIdx value of the next row of Table 3 are brought up to create the combination.

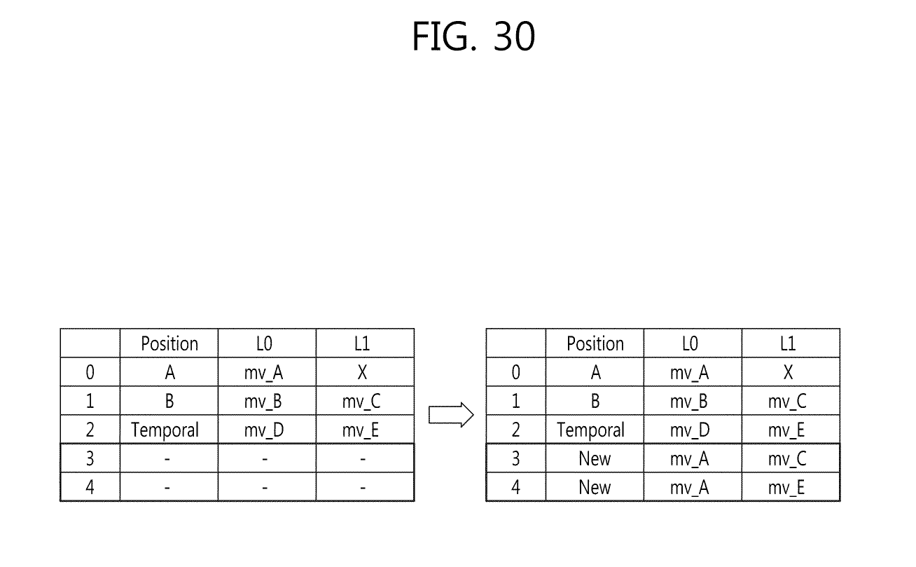

FIG. 30 illustrates an example of filling in an empty MERGE list using a combination method.

Referring to FIG. 30, the existing MERGE list is configured with three blocks, including current blocks A1 and B1 at the spatial position and a temporal current block at the temporal position. The third index in the MERGE list is left empty, and as per the indexes of Table 3, the motion vector of L0 is input with motion vector L0 of the 0th index A1, and the motion vector of L1 is input with motion vector L1 of the first index B1. Likewise, the fourth index is filled.

If although the MERGE list is configured through the above process, the MERGE list is empty, the MERGE list is complete by filling with 0 vectors.

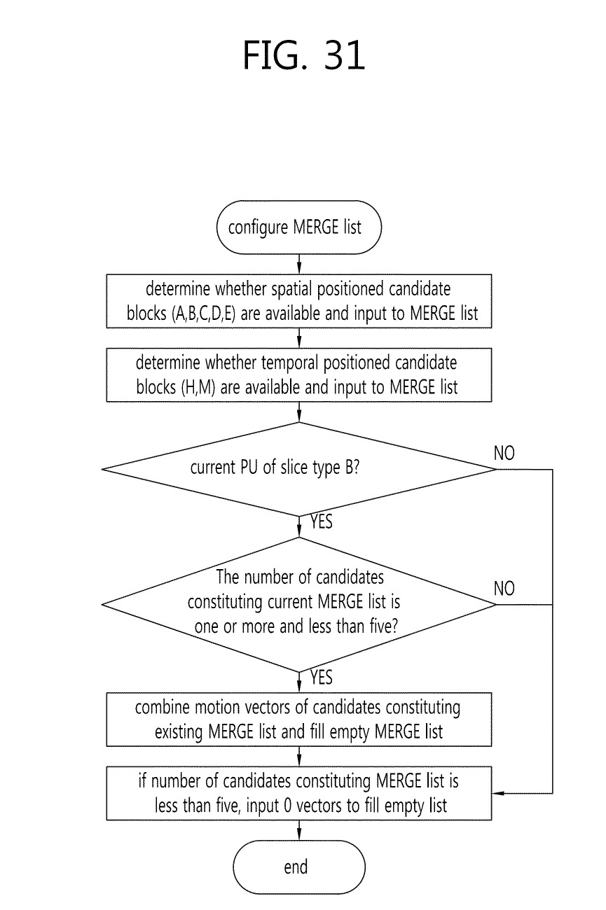

FIG. 31 is a flowchart illustrating an example of a method for configuring a MERGE list.

A method for determining candidate blocks considering object information in determining spatial position candidate blocks in the course of configuring a MERGE list may be proposed, in which the spatial position candidate blocks are limited depending on the object information to thus reduce encoding complexity while allowing for more precise candidate block determination, resultantly leading to an enhanced encoding efficiency.

The HEVC MERGE list configuration method does not use object information in determining a candidate block either. Accordingly, this may be proposed as a method for configuring a MERGE candidate list through the object information using the depth information. In the proposed method, motion information is restricted on all the neighbor candidate blocks based on the object information in configuring a MERGE candidate list through the object information based on the depth information, thus reducing the complexity in the MERGE candidate list configuration method. Further, the encoding efficiency may be increased by a method of first storing the motion information on the blocks of the same object.

The propose method include a method of using depth information in a method for up to four spatial position candidate blocks in configuring a MERGE candidate list. An example may be a method of differentiating objects using the depth information and first storing the block of the same object as the current PU block corresponding to the current PU block generating the MERGE candidate list and its neighbor block.

Referring to FIG. 27, it may be separated on a per-object basis based on the depth information, and this may be shown corresponding to the current PU (block X) used as the MERGE list and neighbor blocks.

In the method according to an embodiment of the present invention, as shown in FIG. 27, per-object distinction is made based on the depth information and is shown corresponding to the current PU (block X) and neighbor blocks used in the MERGE list. In the proposed method, as shown in FIG. 31, the MERGE list is configured by prioritizing candidate blocks B, C, and E in the MERGE list except A and D of not the same object, and then, the MERGE list adds candidate blocks in the order of A and D.

(1) If neighbor blocks A, B, C, D, and E are all present in the same object as the current PU (block X), the existing AMVP list configuration method is used.

(2) If among neighbor blocks A, B, C, D, and E, any is not present in the same object as the current PU (block X), the neighbor blocks not in the same object are excluded, and the existing MERGE list configuration method is used to store the spatial position candidates. Thereafter, the excluded candidate blocks are stored as spatial position candidates in the order of A, B, C, D, and E using the existing MERGE list configuration method.

(3) The temporal positioned candidate blocks are stored using the existing MERGE list configuration method, and the MERGE list is configured according to the existing MERGE list configuration method, and is then terminated.

FIG. 32 is a flowchart illustrating an embodiment for a method for configuring a MERGE list as proposed.

Referring to FIG. 32, the MERGE list configuration method according to another embodiment of the present invention proceeds with a few distinctions as compared with the above-described MERGE list configuration method.

The existing method starts to configure a MERGE list from determining motion information using the spatial position candidate blocks. In the proposed method, however, starting with reading the object information according to the corresponding block and the neighbor block, an object determination is performed depending on the object information of the current prediction block X and the neighbor block, and a MERGE list is configured prioritizing the current blocks in case the block X and the corresponding spatial position candidate blocks are of the same object. Thereafter, the other candidate blocks are configured in the MERGE list in the order of the candidate blocks of not the same object and the temporal positioned candidate blocks. In this case, if the MERGE list has an empty space, configuring the list may be done in the same manner as the existing method.

MERGE List Configuration Considering Object Information

In the MERGE list configuration process, after a list is configured using spatial position candidate blocks and temporal positioned candidate blocks, if the slice type of the current slice is slice B, and the number of the candidates configured in the MERGE list is one or more and less than five, a method of determining candidate blocks considering object information may be proposed for a method of filling up the MERGE list by a combination of the candidates in the existing MERGE list, and such method restricts the MERGE list candidates depending on the object information, and thus more precise candidate blocks may be determined, thus increasing encoding efficiency.

The HEVC MERGE candidate list configuration method does not use object information in determining a candidate block either. Accordingly, this may be proposed as a method for configuring a MERGE candidate list using the depth information. In the proposed method, motion information is restricted on all the neighbor MVP candidate blocks based on the object information in configuring a MERGE candidate list based on the depth information, and thus, in the MERGE candidate list configuration method, encoding efficiency may be increased by a method of first storing the motion information on the blocks of the same object.

The proposed method includes a method in which in configuring a MERGE candidate list, spatial position candidate blocks and temporal positioned candidate blocks are used to configure a list, and if the current slice type is slice B, and the number of candidates in the configured MERGE list is one or more and less than five, the candidates in the already configured MERGE list are combined to generate motion information using depth information. An example may be a method of differentiating objects using the depth information, and upon generation of motion information by combining the already configured MERGE candidate list, first combining the motion information of the blocks of the same object as the current PU block corresponding to the current PU block and its neighbor blocks to thus create motion information.

Referring to FIG. 27 as described above, it may be separated on a per-object basis based on the depth information, and this may be shown corresponding to the current PU (block X) used as the MERGE list and neighbor blocks.

In the method according to an embodiment of the present invention, per-object distinction is made based on the depth information and may be shown corresponding to the current PU (block X) and neighbor blocks used in the MERGE list. In the proposed method, the determined blocks are excluded from the spatial position candidate blocks, and B, except A of not the same object as the current PU (block X) in FIG. 30, and Temporal are rearranged at higher positions in order in the MERGE list, and then, motion information is generated using the index order of Table 3 and fills the empty list.

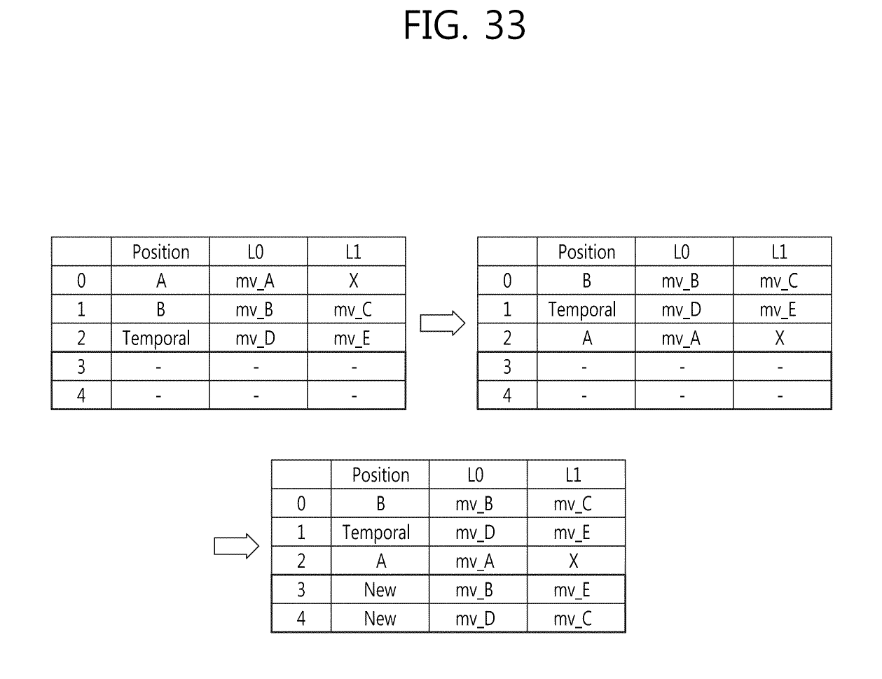

FIG. 33 illustrates an example of a MERGE list combination method based on depth information.

In the method according to another embodiment of the present invention, as shown in FIG. 27, per-object distinction is made based on the depth information and is shown corresponding to the current PU (block X) and neighbor blocks used in the MERGE list. In the proposed method, the determined blocks in the spatial position candidate blocks are included, and the remaining blocks except the blocks of not the same object as the current PU (block X) are rearranged at higher positions in order in the MERGE list, and then, motion information is generated using the index order of Table 3 and fills the empty list.

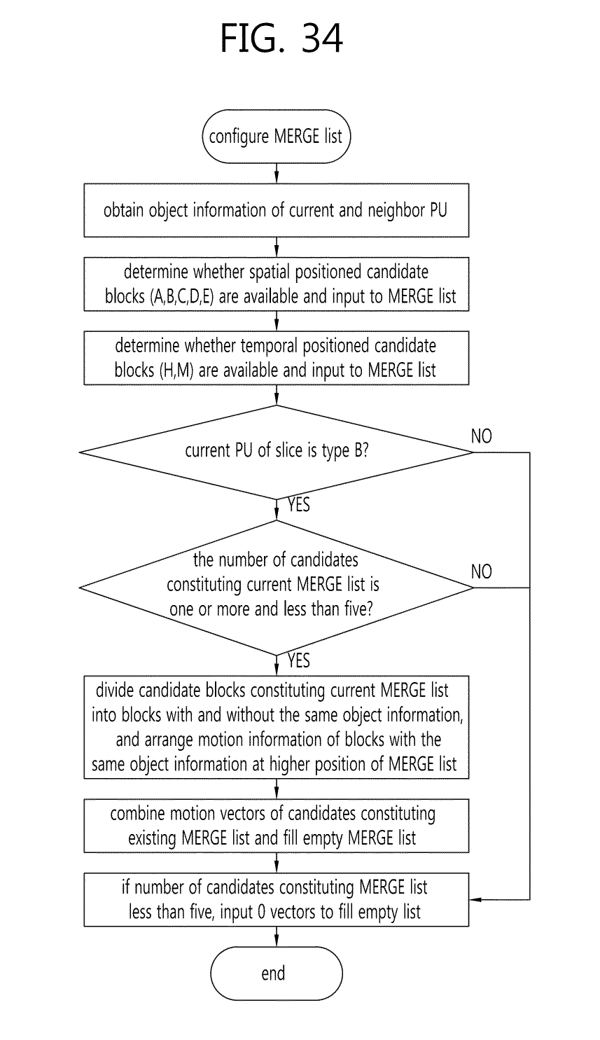

FIG. 34 is a flowchart illustrating an embodiment for a method for configuring a MERGE list as proposed.

Referring to FIG. 34, the method according to an embodiment of the present invention proceeds with a few distinctions as compared with the above-described MERGE list configuration method.

In the existing method, configuring a MERGE list is started with determining motion information using spatial position candidate blocks. In the proposed method, however, a list is configured using spatial position candidate blocks and temporal positioned candidate blocks starting with reading the object information according to the corresponding block and neighbor blocks, and then, in case the number of the candidates in the configured MERGE list is one or more and less than five, the candidates in the already configured MERGE list are combined to generate motion information. In this method, an object determination is made according to the object information of the current prediction block X and the neighbor blocks, and the motion information for the candidate blocks when block X is of the same object as the corresponding candidate blocks in the already configured MERGE list is first combined to create motion information.

In each operation method according to the above described embodiments of the present invention, the targeted range or applicable range may be varied depending on the block size or CU depth. As the variable (i.e., size or depth information) for determining an applicable range, a value predetermined in the encoder/decoder or a value determined according to a profile or level may be used, or if the encoder specifies a variable value in the bitstream, the decoder may obtain the variable value from the bitstream. When the applicable range varies depending on the CU depth, an example is shown in the following table. Scheme A may be a scheme that applies only to depths not less than a predetermined depth value. Scheme B may be a scheme that applies only to depths not more than a predetermined depth value. Scheme C may be a scheme that applies only to a predetermined depth value.

TABLE 4

| CU depth indicating applicable range | Method A | Method B | Method C |
|---|---|---|---|
| 0 | X | ◯ | X |
| 1 | X | ◯ | X |
| 2 | ◯ | ◯ | ◯ |
| 3 | ◯ | X | X |
| 4 | ◯ | X | X |

Table 4 represents an example of an applicable range determination scheme that applies the methods according to the present invention in case the given CU depth is 2. (O: applies to a corresponding depth, X: does not apply to a corresponding depth)

In case the methods according to the present invention do not apply all depths, it may be represented in a bitstream with some indicator (flag) or may be represented by signaling with a CU depth value indicating an applicable range that is one larger than the maximum value of the CU depth.

Further, the above-described methods each may apply to color difference blocks in different ways according to the size of the brightness block, and may apply to brightness signal images and color difference images in different manners as well.

TABLE 5

| Brightness block size | Color difference block size | Apply brightness | Apply color difference | Methods |
|---|---|---|---|---|
| 4(4 × 4, 4 × 2, 2 × 4) | 2(2 × 2) | ◯ or X | ◯ or X | A1, 2, . . . |
| | 4(4 × 4, 4 × 2, 2 × 4) | ◯ or X | ◯ or X | B1, 2, . . . |
| | 8(8 × 8, 8 × 4, 4 × 8, 2 × 8 etc) | ◯ or X | ◯ or X | C1, 2, . . . |
| | 16(16 × 16, 16 × 8, 4 × 16, 2 × 16 etc) | ◯ or X | ◯ or X | D1, 2, . . . |
| | 32(32 × 32) | ◯ or X | ◯ or X | E1, 2, . . . |
| 8(8 × 8, 8 × 4, 2 × 8 etc) | 2(2 × 2) | ◯ or X | ◯ or X | F1, 2, . . . |
| | 4(4 × 4, 4 × 2, 2 × 4) | ◯ or X | ◯ or X | G1, 2, . . . |
| | 8(8 × 8, 8 × 4, 4 × 8, 2 × 8 etc) | ◯ or X | ◯ or X | H1, 2, . . . |
| | 16(16 × 16, 16 × 8, 4 × 16, 2 × 16 etc) | ◯ or X | ◯ or X | I1, 2, . . . |
| | 32(32 × 32) | ◯ or X | ◯ or X | J1, 2, . . . |
| 16(16 × 16, 8 × 16, | 2(2 × 2) | ◯ or X | ◯ or X | K1, 2, . . . |
| 4 × 16 etc) | 4(4 × 4, 4 × 2, 2 × 4) | ◯ or X | ◯ or X | L1, 2, . . . |
| | 8(8 × 8, 8 × 4, 4 × 8, 2 × 8 etc) | ◯ or X | ◯ or X | M1, 2, . . . |
| | 16(16 × 16, 16 × 8, 4 × 16, 2 × 16 etc) | ◯ or X | ◯ or X | N1, 2, . . . |
| | 32(32 × 32) | ◯ or X | ◯ or X | O1, 2, . . . |

Table 5 represents an example in which in case the methods are combined, they apply in different ways depending on the size of brightness blocks and color difference blocks.

Among the varied methods shown in Table 5, method Sa 1 is described. In case the size of the brightness block is 8 (8×8, 8×4, or 2×8) and the size of the color difference block is 4 (4×4, 4×2, or 2×4), the MERGE list configuration method according to an embodiment of the present invention may apply to brightness signals and color difference signals.

Among the varied methods above, method Pa 2 is described. In case the size of the brightness block is 16 (16×16, 8×16, or 4×16) and the size of the color difference block is 4 (4×4, 4×2, or 2×4), the MERGE list configuration method according to an embodiment of the present invention may apply to brightness signals, but not to color difference signals.

In other varied methods, the MERGE list configuration method according to an embodiment of the present invention may apply to only brightness signals, but not to color difference signals. Conversely, the MERGE list configuration method according to an embodiment of the present invention may apply only to color difference signals, but not to brightness signals.

The above-described methods according to the present invention may be prepared in a computer executable program that may be stored in a computer readable recording medium, examples of which include a ROM, a RAM, a CD-ROM, a magnetic tape, a floppy disc, or an optical data storage device, or may be implemented in the form of a carrier wave (for example, transmission through the Internet).

The computer readable recording medium may be distributed in computer systems connected over a network, and computer readable codes may be stored and executed in a distributive way. The functional programs, codes, or code segments for implementing the above-described methods may be easily inferred by programmers in the art to which the present invention pertains.

Although the present invention has been shown and described in connection with preferred embodiments thereof, the present invention is not limited thereto, and various changes may be made thereto without departing from the scope of the present invention defined in the following claims, and such changes should not be individually construed from the technical spirit or scope of the present invention.

1-16. (canceled)

17. An intra prediction decoding method, comprising:
receiving image data including depth information;
generating depth configuration information from a portion of the image data;
obtaining intra prediction information using the depth configuration information; and
decoding an image included in the image data based on the obtained intra prediction information.

18. The intra prediction decoding method of claim 17, further comprising setting the number of prediction modes for intra prediction.

19. The intra prediction decoding method of claim 17, further comprising setting an MPM list configuration for intra prediction.

20. The intra prediction decoding method of claim 17, further comprising setting the number of fixed bits of prediction mode encoding for intra prediction.

21. An intra prediction decoding apparatus, comprising:
a receiving unit receiving image data including depth information;
a depth configuration information generating unit generating depth configuration information from a portion of the image data;
an intra predicting unit obtaining intra prediction information using the depth configuration information; and
a decoding unit decoding an image included in the image data based on the obtained intra prediction information.

22. The intra prediction decoding apparatus of claim 21, further comprising a mode number setting unit setting the number of prediction modes for intra prediction.

23. The intra prediction decoding apparatus of claim 21, further comprising an MPM list configuring unit setting an MPM list configuration for intra prediction.

24. The intra prediction decoding apparatus of claim 21, further comprising a fixed bit configuring unit setting the number of fixed bits of prediction mode encoding for intra prediction.

25. A depth information inducing method, comprising:
receiving image data including depth information;
generating depth configuration information from a portion of the image data;
obtaining object information from the depth configuration information; and
configuring a merge candidate list by using the depth configuration information and the object information.

26. The depth information inducing method of claim 25, further comprising obtaining, from the image data, motion information associated with a spatial position or a temporal position by using the depth configuration information.

27. The depth information inducing method of claim 26, further comprising decoding an image included in the image data based on the obtained motion information and the merge candidate list.

28. The depth information inducing method of claim 27, wherein configuring the list includes first using motion information on a candidate block in a case where a block to be predicted and the candidate block of the merge candidate list are determined to be the same object according to the object.
